(19) United States
(12) Patent Application Publication
(10) Pub. No.: US 2023/0091248 A1
(43) Pub. Date: Mar. 23, 2023

(54) SKILL BASED INTELLIGENT SWARMING WITH SKILL TRACKING AND DEVELOPMENT

(71) Applicant: salesforce.com, inc., San Francisco, CA (US)

(72) Inventors: Shuoqiang Kevin Wang, Santa Clara, CA (US); Devra Struzenberg, Walnut Creek, CA (US); Battugs Chadraa, Redmond, WA (US); Wei-chen Wang, Santa Clara, CA (US); Wen Zhai, Redmond, WA (US); Pen Cheung Chu, Bellevue, WA (US); Utkarsh Jain, Redmond, WA (US); Amber Bouabdallah, San Francisco, CA (US)

(21) Appl. No.: 17/448,301

(22) Filed: Sep. 21, 2021

(51) Int. Cl. G06Q 50/20; G06Q 10/06

(52) U.S. Cl. CPC G06Q 50/2057; G06Q 10/0639

(57) ABSTRACT

Techniques are described for assigning users to swarms based on skill and generating recommendations for increasing skill proficiency. In some implementations, a request specifying a set of requirements for completing a task includes at least one required skill, optionally in combination with a required minimum proficiency value(s). Metrics can be generated based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill. The computer system can identify a first skill for improving the metrics, identify a user for becoming associated with the first skill, and send a notification recommending an online learning resource relating to the first skill.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to managing collaborative projects through automated selection of team members based on skill and computer infrastructure to provide a platform for collaboration between team members. The present disclosure also relates to tracking of skill resources and skill usage across projects and across different users in an organization, in order to improve a computer system's ability to fulfill work-related requests through selective development of skills.

### BACKGROUND

Enterprise organizations often include personnel with diverse skill sets and who are spread across different functional groups such as human resources, accounting, legal, engineering, etc. The advent of Internet-based communication and online collaboration tools has enabled users within an organization to work as a team to complete a project more efficiently. Projects vary in scope and complexity and can arise in different contexts, such as customer service (e.g., technical or after-sales support), research and development, and business development (e.g., pursuing sales opportunities).

Finding the right team members can be challenging, especially when a project requires expertise in multiple skill areas and the users who possess the required skills are unknown to the person responsible for handling/overseeing the project. In some instances, no user in the organization possesses the requisite skill or no user with the requisite skill is available to work on the project. Team formation is often the result of manually reassigning responsibility for a project to another user in an ad hoc fashion, with responsibility passing from one user to the next as each user discovers in turn that they lack the competence to address one or more aspects of the project.

### BRIEF DESCRIPTION OF THE DRAWINGS

The included drawings are for illustrative purposes and serve only to provide examples of possible structures and process operations for the disclosed techniques. These drawings in no way limit any changes in form and detail that may be made to implementations by one skilled in the art without departing from the spirit and scope of the disclosure.

FIG. 1 is a diagram of an example computing environment incorporating one or more implementations.

FIG. 2 illustrates a swarm record according to some implementations.

FIG. 3 is a flow diagram of a process for creating a swarm, in accordance with some implementations.

FIG. 4 is a flow diagram of a process for modifying a swarm, in accordance with some implementations.

FIG. 5 is a flow diagram of a process for closing a swarm, in accordance with some implementations.

FIG. 6 is a flow diagram of a process for reopening a swarm, in accordance with some implementations.

FIG. 7 is a flowchart of a process for adding members to a swarm, in accordance with some implementations.

FIG. 8 illustrates a user record according to some implementations.

FIG. 9 illustrates a combined report according to some implementations.

FIG. 10 illustrates the calculation of a heat level metric according to some implementations.

FIG. 11 illustrates an example of a graph of nodes that can be used to compute a distance-to-user metric, according to some implementations.

FIG. 12 illustrates the calculation of a distance-to-user metric according to some implementations.

FIG. 13 illustrates an online learning database according to some implementations.

FIG. 14 illustrates an example of a data model usable for representing information in a computer system configured to provide recommendations for learning resources, in accordance with some implementations.

FIG. 15 is a flowchart illustrating a process for recommending learning resources, in accordance with some implementations.

FIG. 16A shows a system diagram illustrating architectural components of an applicable environment, in accordance with some implementations.

FIG. 16B shows a system diagram further illustrating architectural components of an applicable environment, in accordance with some implementations.

FIG. 17 shows a system diagram illustrating the architecture of a multi-tenant database environment, in accordance with some implementations.

FIG. 18 shows a system diagram further illustrating the architecture of a multi-tenant database environment, in accordance with some implementations.

### DETAILED DESCRIPTION

Examples of techniques for providing various skill-related functionality are described herein with reference to certain implementations. These examples are being provided solely to add context and aid in the understanding of the present disclosure. It will thus be apparent to one skilled in the art that the techniques described herein may be practiced without some or all of these specific details. In other instances, well known process operations have not been described in detail in order to avoid unnecessarily obscuring the present disclosure. Other applications are possible, such that the following examples should not be taken as definitive or limiting either in scope or setting.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having a computer-readable program code embodied therein.

Aspects of the present disclosure relate to computer-implemented techniques for tracking the availability and skill level of users within an organization in order to determine, via a matching engine of a computer system and in response to a request to form a team, which users are suited to become members of the team. As used herein, the term “swarm” refers to a group of users that have joined together to form a team; and the term “swarming” refers to a process of creating a swarm, which can encompass various operations such as identifying candidate users for becoming swarm members, sending invitations to join a swarm, and allocating computing resources for use by swarm members.

In some implementations, the computer system may be configured to match users against swarm-related requests (also referred to herein as “task requests”), which can include, for example, requests to create swarms and requests to modify existing swarms. Such requests may specify a set of requirements for a swarm, for example, the total number of swarm members, one or more skills required for the swarm, and/or the skill level required for each skill. The computer system may include or have access to a collaboration tool that provides swarm members with a way to communicate and work with each other (e.g., a message board or chat room) and/or share materials (files, documents, etc.). The matching may involve identifying, based on user information maintained by the computer system, one or more users who satisfy the set of requirements. The computer system may track the status of a swarm to determine, for example, whether a swarm is currently active (open), inactive (closed), and/or who the members are. Closed swarms can be reopened with the same or a different set of requirements. To expedite reopening of swarms, the computer system can maintain information about existing swarms and provide a requesting user with access to such information. Thus, the computer system may be configured to not only facilitate swarm creation, but also to manage swarms and computing resources (e.g., resources provided by a collaboration tool) that are allocated to swarms.

Aspects of the present disclosure relate to techniques for improving a computer system's ability to match users against swarm-related requests. Consequently, subsequent requests can be processed with reduced latency compared to earlier requests. In some implementations, matching ability is improved through analyzing user information and information about swarm-related requests, in order to identify skills to be developed by users and generate recommendations to users regarding the identified skills. The computer system may include or be coupled to an online learning system that hosts learning resources, where the learning resources are accessible to user devices over a network. Learning resources can include, but are not limited to, online courses that relate to specific skills. In some implementations, learning resources may include resources derived from swarm activity, e.g., a log of activity recorded using a collaboration tool.

When users learn new skills or increase their skill proficiency, the population of users that the computer system can identify as potential swarm members increases. Since tasks that are the subject of subsequent requests are likely to involve skills associated with earlier requests, the computer system can be expected to match users faster so that future swarms are established in a timelier manner. This also enhances the operational efficiency of the organization to which the users belong. Additionally, individual users may benefit from being notified about ways to develop skills that are relevant to their own interests or roles within the organization. Further, the computer system may be configured to track user skill progression and update user skill information based on swarm activity and/or learning activity. This can improve the accuracy of the matching, and the computer system may also provide users with the ability to monitor their own skill development.

In the example implementations described below, information processed by a computer system to provide the functionality disclosed herein can be organized as data structures that are stored, for example, in memory or in one or more databases. Examples of such data structures, which can be arranged as database records or data objects, are provided for illustration purposes only. One skilled in the art will understand that the information in the data structures can be organized in different ways, including combining or splitting of data structures so that the information is stored in a more collected or distributed fashion.

The disclosed implementations may include a computer-implemented method for providing recommendations targeting development of select skills. The method involves receiving, by a computer system, task requests from computing devices of different users, where at least one task request specifies a set of requirements for completing a task. The set of requirements includes at least one required skill or the at least one required skill in combination with a required minimum proficiency value for the at least one required skill. The task is assignable by the computer system to multiple users within a set of users. The method further involves accessing, by the computer system, a user database containing user records for the set of users. At least one user record indicates one or more skills that a respective user is associated with and the respective user's proficiency value in the one or more skills. The method further involves generating, by the computer system, a first set of metrics. At least one metric in the first set of metrics is generated for a corresponding skill in a list of skills maintained by the computer system, based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill. The method further involves identifying, by the computer system, a first skill among the list of skills for improving the first set of metrics; and identifying, by the computer system based on the user records, at least one user in the set of users as a candidate for becoming associated with the first skill. The computer system then sends a notification to a computing device of the at least one user, the notification including an instruction for accessing an online learning resource relating to the first skill.

The disclosed implementations may include a computer system with one or more processors and memory storing instructions that, when executed by the one or more processors, configure the computer system to receive task requests from computing devices of different users. At least one task request specifies a set of requirements for completing a task, the set of requirements including at least one required skill or the at least one required skill in combination with a required minimum proficiency value for the at least one required skill. The task is assignable by the computer system to multiple users within a set of users. The instructions further configure the one or more processors to access a user database containing user records for the set of users, at least one user record indicating one or more skills that a respective user is associated with and the respective user's proficiency value in the one or more skills. The instructions further configure the one or more processors to generate a first set of metrics. At least one metric in the first set of metrics is generated for a corresponding skill in a list of skills maintained by the computer system, based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill. The instructions further configure the one or more processors to identify a first skill among the list of skills for improving the first set of metrics; identify, based on the user records, at least one user in the set of users as a candidate for becoming associated with the first skill; and send a notification to a computing device of the at least one user, the notification including an instruction for accessing an online learning resource relating to the first skill.

The disclosed implementations may include a non-transitory computer-readable medium storing program code, the program code including instructions that are executable by one or more processors of a computer system to configure the computer system to perform any of the methods disclosed herein.

Any of the disclosed implementations may be used alone or together with one another in any combination. The one or more implementations encompassed within this specification may also include examples that are only partially mentioned or alluded to or are not mentioned or alluded to at all in this brief summary or in the abstract. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

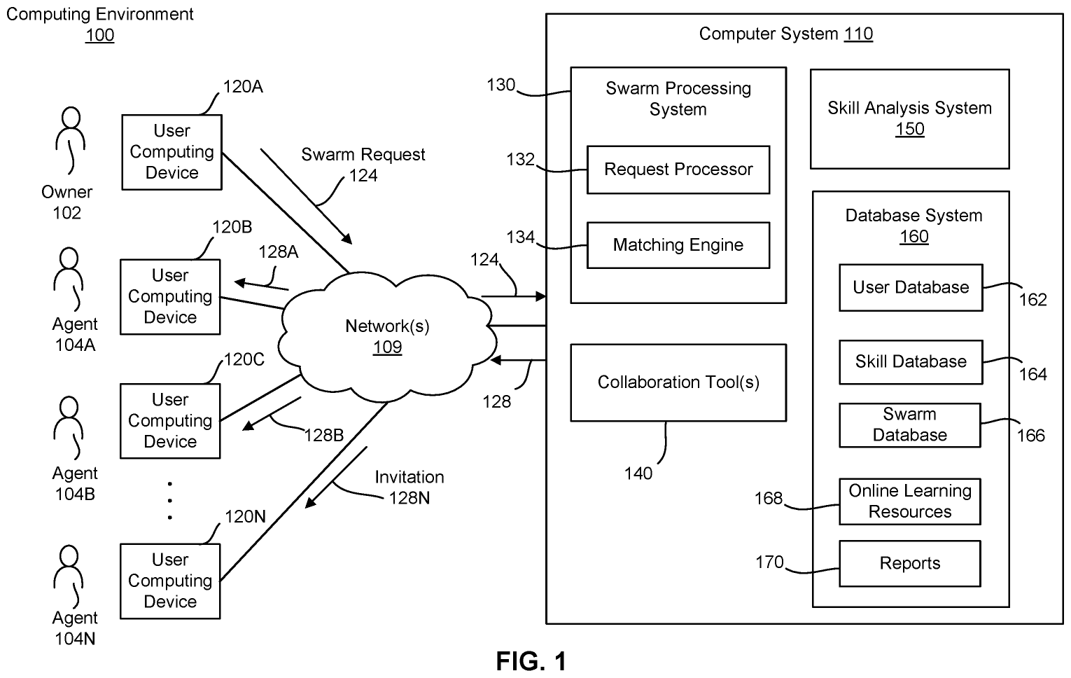

FIG. 1 is a diagram of an example computing environment 100 incorporating one or more implementations. The environment 100 includes a computer system 110 and user computing devices 120 (e.g., 120A, 120B, 120C, and 120N) operated by various users belonging to an organization. In some implementations, the computing environment may be multi-tenanted. According, the functionality provided by the computer system 110 may be provided to users across different organizations. As shown in FIG. 1, the users may include an owner 102 and a plurality of users 104 (referred to herein as “agents”). The owner 102 is a user responsible for a task. A task can be any objective to be completed by one or more users, e.g., swarm members. A task can, for example, be an issue/situation/case to be resolved or a project and may involve one or more sub-tasks or activities. The sub-tasks or activities may or may not be identified at the outset. For instance, a task completed by a swarm may involve steps performed by different swarm members, where the steps were not decided upon at the time that the swarm was initially created.

Agents 104 are users who possess different skills. For instance, an agent 104A may be skilled in web development or software programming, an agent 104B may be skilled in technical support for a particular product or service offered by the organization, and an agent 104N may be skilled in circuit design. An agent can possess more than one skill, and the skills may or may not be related. For instance, it is often the case that an agent having a technical role is knowledgeable about multiple technology areas. Skills may be general or highly specialized. Accordingly, skills may be divided into categories and sub-categories. As described below, one way in which skills may be represented in a computer system is through a graph of nodes, where a node represents a particular skill category and connections between nodes indicate related skills or skill categories. Owner 102 may also have one or more skills and contribute to the work performed by the swarm.

Owner 102 may transmit a swarm/task request 124 to computer system 110. A swarm request can be a request to create a new swarm or a request to modify an existing swarm. Other types of swarm requests are also possible and include, for example, a request to close a swarm or a request to reopen a closed swarm. As part of fulfilling a swarm request, the computer system 110 may assign agents 104 as swarm members in response to the agents accepting invitations 128 sent by the computer system 110. For instance, the computer system 110 may send an invitation 128A to user computing device 120B operated by agent 104A based on determining that the agent 104A meets one or skill requirements specified in the swarm request 124. Similarly, the computer system 110 may send invitations 128B and 128N to user computing devices 120C and 120N operated by agents 104 B and 104N in response to determining that the agents 104B and 140N meet one or skill requirements specified in the swarm request 124.

Communications among the various computing elements shown in FIG. 1 (e.g., between user computing devices 120 and computer system 110) may occur over one or more networks 109. The network(s) 109 can include wired and/or wireless networks and may be implemented as a private network (e.g., a local area network or private area network), a public network (e.g., the Internet), or a combination of private and public networks.

Each of the user computing devices 120 can be implemented as a general-purpose computing system including one or more processing units (e.g., a Central Processing Unit (CPU) or microprocessor), memory, and program instructions stored in the memory. Examples of computer systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. A user computing device 120 may include or be communicatively coupled to one or more input devices (mouse, keyboard, microphone, etc.) and/or one or more output devices (display monitor, speaker, etc.).

Similarly, the computer system 110 can include one or more processing units, memory, and program instructions stored in the memory. In some implementations, the computer system 110 may be implemented as a distributed set of computing components that provide processing, storage, or other computing resources for implementing the functionality described herein. Accordingly, the computer system 110 can include servers, networking components (routers, switches, load balancers, etc.), and/or the like. As shown in FIG. 1, the computer system 110 may include a swarm processing system 130, one or more collaboration tools 140, a skill analysis system 150, and a database system 160. Each of the components 130, 140, 150, and 160 may be implemented in hardware, software, or a combination of hardware and software.

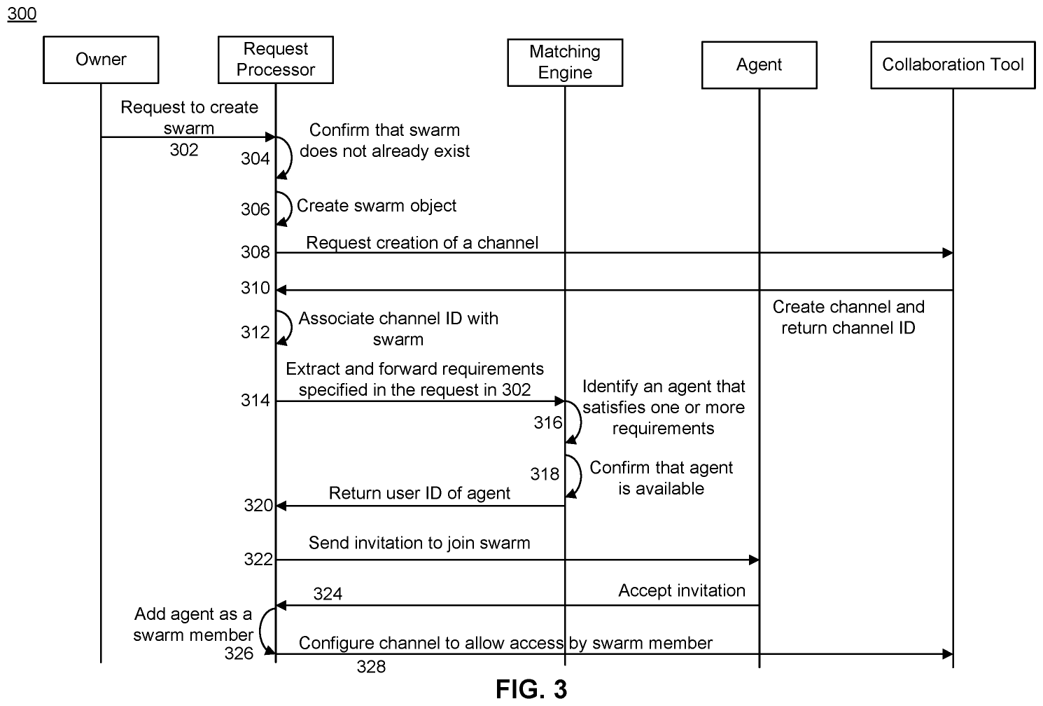

Swarm processing system 130 is configured to process swarm requests such as the swarm request 124. The processing of a swarm request can be performed by a request processor 132 and a matching engine 134. Upon receiving a swarm request, the request processor 132 may parse the request to extract the contents of the request for processing. The request processor 132 may be configured to process swarm requests in accordance with execution flows that are specific to the type of request. Examples of execution flows for requests that relating to creating, modifying, closing, and reopening swarms are described below in connection with FIGS. 3 to 6.

As discussed above, a swarm request may specify a set of requirements for a swarm. Examples of such requirements include the total number of swarm members, one or more skills required in order to complete a task that is the subject of the swarm and, in some instances, a required skill level (e.g., a required minimum proficiency value) for each skill specified in the swarm request. For instance, as part of generating the swarm request 124, the owner 102 may provide input indicating that a certain number of agents with a first skill and a certain number of agents with a second skill are required. Upon extracting the set of requirements, the request processor may forward the requirements to the matching engine 134 for identifying agents 104 that satisfy the requirements.

Matching engine 134 is configured to identify agents 104 who satisfy the requirements and return a list of candidate agents. To identify the candidate agents, the matching engine 134 may access user information indicating what skills are associated with each agent (skills an agent possesses). The user information can be stored in a user database of the database system 160. After a candidate agent is identified, the swarm processing system 130 can generate an invitation 128 for transmission to the computing device 120 of the candidate agent. The invitation can be generated by the matching engine 134 itself or the request processor 132 based on the results of the matching performed by the matching engine 134.

In some instances, the matching engine 134 may identify multiple candidate agents at once. Accordingly, invitations 128 may be sent concurrently to different user computing devices 120. Alternatively, the matching engine 134 may be configured to identify candidate agents one at a time or in batches, for example, to find an agent that matches a first skill requirement before finding an agent that matches the next skill requirement. Thus, the invitations sent in response to the swarm request 124 do not have to be sent together. Further, in some implementations, the swarm request 124 may involve multiple messages or communications sent from the computing device 120A of the owner 102. Each message or communication may specify a different requirement and may be processed separately to identify one or more corresponding candidates. For example, a first message sent as part of the swarm request 124 may specify a first skill and a second message sent as part of the swarm request 124 may specify a second skill.

If an agent accepts an invitation, the swarm processing system 130 adds the agent as a swarm member to a digital representation of the swarm (e.g., a swarm object). Adding the agent as a swarm member assigns the agent to the swarm and creates an association between the agent and the swarm, for example, between a user identifier (ID) of the agent and the digital representation of the swarm. Each swarm created through the computer system 110 may have a corresponding digital representation, for example, in a swarm database 166 within the database system 160.

If an agent declines an invitation, the swarm processing system 130 may send an invitation to an alternate candidate. The alternate candidate may have been identified when the matching engine 134 processed the requirements earlier to identify the agent who declined the invitation. For instance, the matching engine 134 may be configured to generate a list of candidates who have a required skill, issue a number of invitations equal to the number of agents specified for that skill, and wait for responses to the invitations before determining how many invitations to send to alternate candidates. Alternatively, the swarm processing system 130 could send invitations to all matching candidates and fill membership vacancies in the order in which acceptances to the invitations are received.

It may not always be possible to fully satisfy the requirements of a swarm request. For example, there may be instances where no agent has a required skill. There may also be instances where there is at least one agent with the required skill, but none of the agents with the required skill is available to be assigned to the swarm. This may be a result of work or case load constraints. For example, computer system 110 may prevent an agent from being assigned to more than a certain number of active swarms at any given time. The limit on the maximum number of active swarms to which an agent can be assigned may be configurable, for example, by an administrative user of the organization to which the owner 102 and the agents 104 belong.

One option for handling situations where the requirements of a swarm request are not fully satisfied is to place the swarm request on a queue and mark the swarm as inactive until the requirements can be satisfied. As agents become available, the swarm processing system 130 may prioritize assigning agents to swarms that were requested earlier. In this manner, an agent who has a skill specified in an earlier request and a later request may receive an invitation to the swarm of the earlier request instead of an invitation to the swarm of the later request. The swarm processing system 130 can monitor the status of the agents to issue an invitation when the swarm processing system detects that an agent meeting a requirement that has yet to be satisfied becomes available. Once all the requirements of a swarm request that has been queued are satisfied and the invitations have been accepted, the swarm request can be dequeued and marked active.

To reduce delay in processing of swarm requests, the swarm processing system 130 may be configured to intelligently match agents so that invitations are generated for the best or closest matching candidates. Intelligent matching can be implemented algorithmically through hardware or program logic that evaluates agents using multiple factors besides skill or skill level. Any attribute associated with a user can be a factor that the matching engine 134 takes into consideration when deciding whether to issue an invitation. For example, the matching engine 134 may evaluate a combination of skill, skill level, seniority level, prior experience (e.g., past participation in swarms involving the same required skill), and the like. The matching engine 134 may assign a weight to each factor, with some factors (e.g., skill and skill level) having a greater weight than others, in order to calculate a score for each agent and select the agent with the best score as a candidate to whom an invitation is sent. In some instances, this may result in an invitation being sent to a candidate who does not possess the exact skill required but possesses a closely related skill. For example, in response to a swarm request requiring a skill in a specific category, an invitation could be sent to a candidate who possesses skill in a broader, parent category.

Intelligent matching can also be implemented using machine learning. For instance, matching engine 134 may include a neural network or machine learning model configured to process user attributes in conjunction with swarm requirements to generate a list of candidates as output inferences. The neural network or machine learning model can be pre-trained, using hypothetical requirements and hypothetical user attributes, to derive the initial parameters of the neural network or machine learning model. Further, the parameters of the neural network or machine learning model can be updated using the requirements and user attributes of swarms that have actually been created.

Collaboration tools 140 are components that provide an online platform for members of a swarm to communicate and collaborate with each other. In some implementations, a collaboration tool 140 may be a software program executed on the computer system 110 in conjunction with client software executed on user computing devices 120. A collaboration tool 140 may provide messaging capabilities that enable agents to send audio and/or visual communications to each other such as instant messages, email, message board posts, and/or the like. Collaboration tool 140 may also include calendar functionality that permits members of a swarm to schedule meetings (e.g., telephone or videoconferences) with each other.

Communications between members of a swarm may be conducted using resources dedicated to that swarm. For instance, a collaboration tool may provide a dedicated channel to each swarm, where the channel includes a private message board (e.g., for grouping together conversations between all the members of the swarm and/or between two swarm members) and can be accessed by logging into the collaboration tool (e.g., via a web browser or client application). Communications may also involve sharing of files, documents, or other materials related to a task to be completed. In some implementations, a collaboration tool may provide the ability for agents to work on a file or document simultaneously, e.g., to edit or comment on a document. Thus, a collaboration tool may include data management functionality such as locking of files, releasing of locks, merging changes from multiple users, and/or the like.

Collaboration tools 140 can be configured to capture and record activity within a swarm. Examples of activity that may be recorded include electronic communications such as emails, messages posted to a message board, audio or video recordings of meetings, shared files or documents, and actions performed by swarm members. A collaboration tool may generate a channel-specific activity log as a record of events that occurred over the course of completing a task. The activity log can be shared with other users besides members of the swarm. The extent to which recorded activity is shared with other users can be configurable. For instance, the owner associated with the swarm (e.g., owner 102) may configure sharing of electronic messages between swarm members but disallow sharing of files or documents. The shared activity log can be metadata-tagged or indexed (e.g., using a required skill as a keyword) to make the activity log searchable by users.

Skill analysis system 150 is configured to track the usage and distribution of skills within one or more organizations. The skill analysis system 150 may track skill usage based on incoming swarm requests. For each new swarm request, the skill analysis system 150 can identify which skills have been specified in the swarm request and generate a usage report regarding skills that are in-demand. To determine whether a skill is in-demand, the skill analysis system 150 may generate one or more metrics based on statistical analysis of swarm requests. For example, as described below, a “heat level” metric can be generated for at least one skill in a list of skills maintained by the computer system 110, as a function of several factors including the extent to which users are missing required skills, missing required skill levels, and delay (referred to herein as routing latency) in assigning members to swarms due to unavailability of users with the requisite skills/skill levels.

The factors used to generate the heat level metric can include information generated as a result of matching (e.g., processing performed by matching engine 134). For example, skill analysis system 150 may generate a missing skill report indicating a total number of instances in which an agent assigned to a swarm does not have a required skill. Similarly, skill analysis system 150 may generate a missing skill level report indicating a total number of instances in which an agent assigned to a swarm has a skill level (e.g., a proficiency value) that is below a required skill level (e.g., a minimum proficiency value). Further, skill analysis system 150 may generate a routing latency report indicating an amount of time (e.g., total or average duration) elapsed between receiving swarm requests and assigning agents to swarms. For example, for each swarm request, the skill analysis system 150 may compute the difference between a timestamp corresponding to when the swarm request was made (e.g., received from user computing device 120A) and a timestamp corresponding to when an agent accepts an invitation. The skill analysis system 150 may then sum or average this difference across all swarm requests to determine the routing latency.

The usage report and any underlying reports used to generate the usage report (e.g., missing skills, missing skill level, routing latency) can be generated based on swarm requests received over a period of time and can be repeated at regular intervals or on-demand. For example, the usage report may be a daily report representing swarm requests received over the course of a day, a weekly, a month, etc. The skill analysis system 150 may generate a usage report based on swarm requests within a single organization, across multiple organizations, or for specific departments or subdivisions of an organization. Thus, usage reports may be generated at different levels of granularity to identify where skills are most in-demand.

Skill analysis system 150 can track skill distribution based on user information maintained, for example, in a user database 162 of the database system 160. The user database 162 may store a user record for each user (e.g., owner 102 and agents 104), where the user record indicates skills associated with the user, an indication of skill level, and/or other skill-related information. In some implementations, the skill analysis system 150 generates a user report indicating the extent to which a user possesses a skill that is represented in the computer system 110. For example, as described below, the computer system can, for at least one skill in the list of skills, generate a “distance-to-user” metric indicating the distance between a user and a skill in the list of skills. In this manner, the skill analysis system 150 may evaluate each user's competence in at least one skill known to the computer system 110. The distance-to-user metric can be used to, among other things, match users against swarm requests. As with usage reports, user reports can be generated at different levels of granularity (e.g., within or across organizations) and for different time periods (daily, weekly, monthly, etc.). Accordingly, the skill analysis system 150 may be configured to detect changes in the distribution of skills and skill level over time. Such changes may, for example, be a result of users being added to or removed from the computer system 110 (e.g., based on agents joining or leaving an organization), users becoming associated with new skills (e.g., based on taking online courses, completing certification training), and/or users becoming more proficient in skills they already possess. The user database 162 can be updated to reflect these changes.

In some implementations, the skill analysis system 150 is configured to recommend online learning resources to users. Skill analysis system 150 may send recommendations to users electronically, e.g., by email. The recommendations can target skills that the skill analysis system 150 has identified as being in-demand. For instance, the skill analysis system 150 may generate a daily ranking of skills according to heat level and send recommendations for the top ten skills. Further, the skill analysis system 150 may identify users to send recommendations to. To identify which users to send recommendations to, the skill analysis system 150 can determine, for at least one user and based on the above-mentioned distance-to-user metric and/or other user-related factors, whether it is appropriate for the user to acquire or increase proficiency in the recommended skill. For example, skill analysis system 150 can, for a recommended skill (e.g., a top ten skill), determine which users are within a threshold distance of the recommended skill. For a user within the threshold distance, the skill analysis system 150 can identify an online learning resource that relates to the recommended skill and that is of an appropriate difficulty level for the user. If there exists an online learning resource of appropriate difficulty level, the skill analysis system 150 may then generate a notification to the user recommending the online learning resource. Another factor that the skill analysis system can consider when deciding whether to recommend an online learning resource is a user's stated interests or preferences regarding skill or career development. For example, a user record in the user database 162 may include a user profile indicating technology areas that the user is interested in learning about.

In addition to generating recommendations for in-demand skills, the skill analysis system 150 can generate recommendations for new skills. Computer system 110 can identify new skills based on swarm requests. If an incoming swarm request specifies a skill that is not already included in the list of skills maintained by the computer system 110, the list of skills can be updated to include this skill. Because a new skill may not have any online learning resources associated with it, the computer system 110 can, upon identifying a new skill, generate a request to create online learning resources for the new skill. Likewise, the computer system 110 can generate requests to create online learning resources for in-demand skills. Requests to create online learning resources can be sent to one or more users that the computer system identifies as having a related skill. Upon receiving such a request, a user may supply an online learning resource (e.g., authoring a knowledge article) and other users who receive similar requests may also contribute their own learning resources. The skill analysis system 150 may prioritize recommending learning materials for new skills over existing skills.

Computer system 110 can maintain its own online learning resources 168 that are accessible to users, e.g., through a web portal. As mentioned above, learning resources can include knowledge articles or materials supplied by users. The online learning resources 168 can also include courses that users can take. Courses can, for example, be self-paced learning modules or classes taken according to a set schedule. Each course can relate to one or more skills and may have a course skill level associated with it. The computer system 110 may track a user's progression through a course, for example, based on percentage of course material completed, completion of quizzes or exams, and/or the like.

Database system 160 can be configured to store the user database 162, the online learning resources 168, and other information used by the computer system 110 to assign users to swarms and/or to recommend learning resources to users. For example, as shown in FIG. 1, the database system 160 may further include a skill database 164, a swarm database 166, and reports 170. Although depicted as a single block, the database system 160 can be implemented using distributed storage elements including, for example, cloud servers and external data centers.

Skill database 164 may include the list of skills maintained by the computer system 110. Each skill in the list of skills can be represented as a separate data object in the skill database 164. A skill object may include a corresponding skill ID and information or a link (e.g., pointer) to information about the skill. For instance, a skill object can include a value for the heat level metric of the skill and an indication of the difficulty level of the skill. Skill difficulty level is similar to the above-mentioned course skill level in that skill difficulty level represents how difficult a skill is to acquire (e.g., relative to other skills in the list of skills), whereas course skill level represents the level of skill involved in the course.

In addition to skill objects, the skill database 164 may include a representation of how skills are related to each other. For example, the skill database 164 may include one or more graphs (e.g., ontology trees) of nodes, where individual nodes represent different skills or skill categories. The nodes can be arranged hierarchically according to category so that parent nodes correspond to a more general category of a skill represented by a child node. Accordingly, a skill object can include a pointer or reference to its parent and/or a pointer or reference to its child.

Swarm database 166 may include representations of swarms created by the computers system 110 in response to swarm requests. Each swarm may be represented as a swarm object that includes a swarm ID and information or a link to information about the swarm. For example, a swarm object can indicate who the owner is (e.g., owner 102) and who the other members are (e.g., one or more agents 104). In some implementations, a swarm object may also indicate requirements (e.g., skill or skill level) specified in the swarm request that resulted in creation of the swarm object and/or other swarm-related information such as a channel ID of a channel provided to the swarm by a collaboration tool 140.

Reports 170 may include any of the above-mentioned reports generated by the computer system 110 in connection with matching users against swarm requests or recommending online learning resources. For instance, reports 170 can include usage reports, missing skill reports, missing skill level reports, routing latency reports, and/or user reports. The computer system 110 can be configured to automatically update the reports 170 on a regular basis, e.g., daily, weekly, or monthly, as discussed above. Computer system 110 can, in some instances, make one or more reports 170 available to users. Reports 170 can also be generated on-demand, e.g., based on a request from a user.

Computer system 110 can maintain separate databases for each tenant/organization serviced by the computer system. In a multi-tenanted environment, the computer system 110 may, for example, include a user database 162 and a swarm database 166 for each tenant and restrict access to the databases 162 and 166 to only users associated with the corresponding tenant. However, computer system 110 may access information across tenants as part of matching users or generating recommendations for learning resources. For example, computer system 110 may identify a new skill based on a swarm request from a user associated with a first tenant and, after learning resources have been created for the new skill, recommend the learning resources for the new skill to users associated with a second tenant.

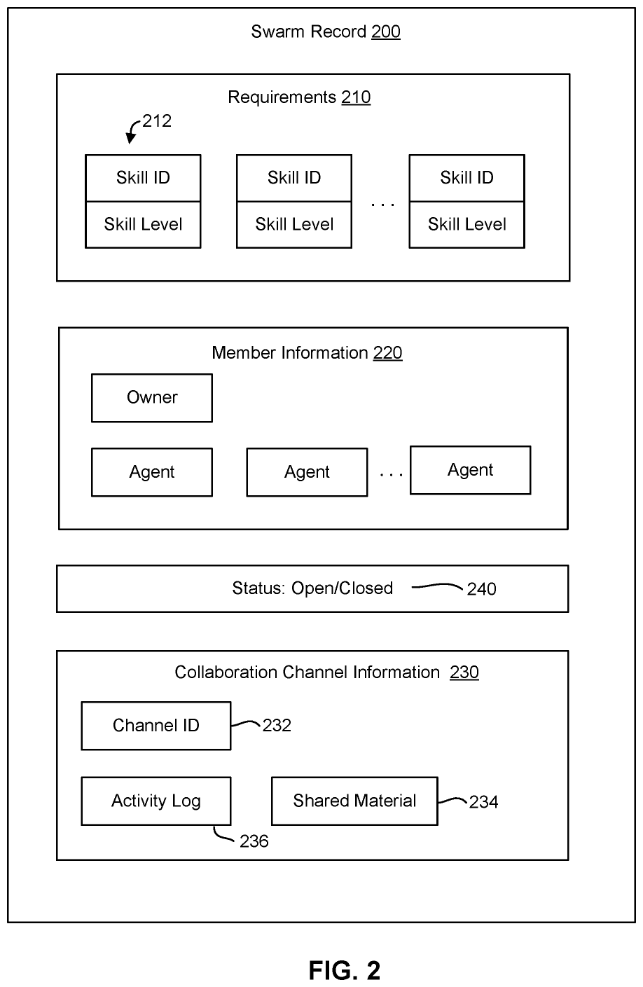

FIG. 2 illustrates a swarm record 200 according to some implementations. Swarm record 200 is an example of a record that can be stored as part of the swarm database 166 in FIG. 1. Swarm record 200 is a collection of information regarding a swarm created as a result of a swarm request and can include a set of requirements 210, member information 220, collaboration channel information 230, and a status indicator 240.

Requirements 210 may include one or more skills 212 specified in the swarm request and, for at least one skill of the one or more skills 212, a corresponding skill level specified in the swarm request. Skill level can be represented in the computer system as a proficiency value, which can be a numeric value within a defined range (e.g., a scale from one to ten). Alternatively, proficiency values can be non-numeric (e.g., low/medium/high or some other qualitative measure of skill level). Requirements 210 can also include, for each skill, how many agents having that skill are needed. A skill 212 can be assigned a unique skill ID. The requirements 210 can be updated through a later swarm request so that the requirements differ from those specified in the initial swarm request.

Member information 220 indicates who the members of the swarm are. For a given swarm, the members include an owner (e.g., owner 102) and one or more agents. The owner and the one or more agents are users known to the computer system, e.g., users represented in the user database 162. The member information 220 can be updated based on changes in membership, by adding or removing users. Membership changes can result from changing the requirements 210. For instance, the requirements 210 may be updated by an owner to add or remove skills, resulting in more or fewer members. As users join or leave the swarm, the owner generally remains the same. That is, responsibility for completing the task that is the subject of the swarm usually stays with the same person. However, there may be instances in which the owner changes (e.g., to a new owner upon reopening of a swarm). Further, agents may be free to disassociate or re-associate themselves. For instance, an agent may decide that they no longer wish to be part of the swarm because they want to work on another swarm. After completing the task for the other swarm, the agent may choose to rejoin the swarm and can do so provided that the membership is not completely filled. Thus, if there is an open spot on the swarm (e.g., a vacancy for a member with a skill that the agent possesses), the computer system may permit the agent to rejoin and, in some instances, may even give the agent priority over other agents who have pending invitations to join.

Collaboration channel information 230 includes information regarding resources made available to the swarm through a collaboration tool 140. Such resources can include a dedicated channel used by swarm members to communicate with each other, as indicated by a corresponding channel ID 232. Further, the information 230 can include information provided by or generated as a result of actions performed by swarm members. For example, swarm record 200 can include a copy of, or a link to, an activity log 236 generated by a collaboration tool. In some implementations, the activity log 236 is locally stored as part of the swarm record 200 upon closing of the swarm. The information 230 can also include material 234 shared between swarm members, such as documents, images, audio or video recordings, source code, etc.

Status indicator 240 represents the current status of the swarm and can be set to indicate that the swarm is open (active) or closed (inactive). An open swarm is a swarm in which the members are actively working on the task that is the subject of the swarm. In general, a swarm can be set open once the requirements 210 for the swarm have been satisfied (e.g., after the last member of the swarm accepts an invitation). A swarm is usually closed once the task has been completed. However, swarms may be closed for other reasons, such as the task being suspended. As discussed below, closed swarms can be reopened. A swarm can be reopened through a new swarm request, which may specify requirements 210 that are different from those specified when the swarm was first created.

FIG. 3 is a flow diagram of a process 300 for creating a swarm, in accordance with some implementations. The process 300 can be performed by one or more processors of a computer system (e.g., computer system 110) with access to user information and using input from computing devices of users joining a swarm. At 302, a request to create a swarm is received by a request processor (e.g., request processor 132) of the computer system. The request is sent from a computing device of an owner (e.g., owner 102). The owner can be any user who wants to complete a task with the help of a swarm. The task may have originated in any number of ways. For instance, the task may have been assigned to the owner by someone else in the organization or from a work queue. As another example, the task may be a project that the owner has designed.

The request received in 302 includes a set of requirements for the swarm being created, and thus the task to be completed. For example, as described above, a swarm request can specify one or more required skills and a required skill level for the one or more required skills, as well as the number of agents/users required (e.g., in total or for a specific skill). Thus, the request in 302 could include a first skill, a minimum proficiency value for the first skill, and a quantity of agents required for the first skill. Similar requirements can be specified for additional skills.

At 304, the request processor confirms that the swarm does not already exist in the computer system. For example, the request processor may check the swarm database 166 to determine whether there exists a swarm with identical attributes (e.g., same owner and same skill requirements). If the swarm already exists, the request processor may return an error message and the process terminates. Otherwise (at 306), the request processor creates a swarm object or other representation of the swarm in the computer system. The swarm object or other representation of the swarm can include, as an attribute, a swarm ID generated for the swarm by the computer system. The swarm ID can be any value (numeric, alphanumeric, alphabetical, etc.) that uniquely identifies the swarm. The request processor can also update an owner attribute of the swarm object to indicate that the current owner is the user who sent the request in 302.

At 308, the request processor sends a request to a collaboration tool for creation of a channel. The computer system can be configured with multiple collaboration tools 140, in which case the request processor may determine which of the collaboration tools to use for the swarm. The collaboration tool to use can be pre-configured (e.g., the organization to which the owner belongs has a software license for a particular collaboration tool) or based on the preference of the owner.

At 310, in response to the request from 308, the collaboration tool creates a channel and returns a channel ID to the request processor. In some implementations, the channel is a collection of computing resources and services accessible through a user interface, e.g., a portal to a webpage hosted on behalf of the swarm. The channel ID can be assigned by the collaboration tool and can be a numeric or alphanumeric value that uniquely identifies the swarm. The channel ID can also be a text string, e.g., a name or description of the swarm. In some cases, the swarm ID and the channel ID may be the same. Creating the channel may involve allocating one or more types of computing resources (storage, processing, a dedicated website, etc.) for use as part of communications between swarm members.

At 312, the request processor associates the channel ID with the swarm. The processing in 312 may involve updating the swarm object to include the channel ID so that the swarm object can be used to look up the corresponding channel assigned to the swarm. In general, any link or mapping between the swarm ID and the channel ID is sufficient to associate the channel ID with the swarm.

At 314, the request processor extracts the requirements from the request that was received in 302. The request processor then forwards the requirements to a matching engine (e.g., matching engine 134) of the computer system.

At 316, the matching engine identifies an agent that satisfies one or more of the requirements. The matching engine may be configured to perform strict matching so that only agents who fully satisfy one or more requirements are identified. Alternatively, the matching engine can be configured to identify a best or closest-matching agent.

At 318, the matching engine checks to confirm that the agent identified in 316 is available to join the swarm. If the agent is not available, then the matching engine can select a different agent that satisfies the same requirement(s). Otherwise (at 320), the matching engine can communicate to the request processor that the agent identified in 316 has been selected to receive an invitation.

At 320, the matching engine returns a user ID of the agent who was identified in 316, causing the request processor to generate an invitation for the agent associated with the user ID. The invitation can include information about the swarm, and such information may have been supplied as part of the request in 302. For example, the invitation can include a description of a task to be completed, what skill(s) the agent receiving the invitation is expected to contribute, a proposed timeframe in which to complete the task, and/or the like.

At 322, the request processor sends the invitation to the user associated with the user ID. The invitation can be sent electronically using email, text message, etc. and may be read using a computing device of the agent. The invitation may include a clickable link or button to indicate whether or not the agent accepts the invitation. For instance, the invitation may include options to accept, decline, and/or conditionally accept the invitation.

At 324, the agent associated with the user ID accepts the invitation using their computing device. The acceptance is communicated to the computer system electronically, e.g., over one or more networks 109.

At 326, the request processor adds the agent as a swarm member. Adding the agent may involve generating an association between the user ID of the agent and the swarm, e.g., by updating the swarm object to include the user ID of the agent.

At 328, the request processor configures the channel to allow access to the channel by the swarm member (the agent added in 326). Prior to configuring the access for the swarm member, the request processor may have already configured access for the owner (e.g., as part of the request to create the channel in 308). To provide the swarm member with access, the request processor may communicate to the collaboration tool what access rights the swarm member has. The access rights of the swarm member can be the same as or different from those of the owner. The request processor can determine the access rights based on a policy maintained by the computer system (e.g., a policy configured for the organization to which the swarm member belongs) or based on input from an owner (e.g., access rights specified as part of the request in 302). Examples of access rights include the ability to edit documents shared among swarm members, the ability to comment on messages posted by other swarm members, the ability to send private messages to another swarm member, and the ability to view other members' calendars.

The functionality in blocks 316 to 328 can be repeated, e.g., through multiple iterations and as part of a program loop, to identify and send invitations to additional agents who satisfy one or more requirements specified for the swarm. New invitations can continue to be sent until the request processor has determined that no additional agents are to be added, e.g., when the total number of agents who accepted invitations is equal to a maximum allowable size or a target size (e.g., specified by the owner) for the swarm. In this manner, multiple agents can be recruited based on the request in 302.

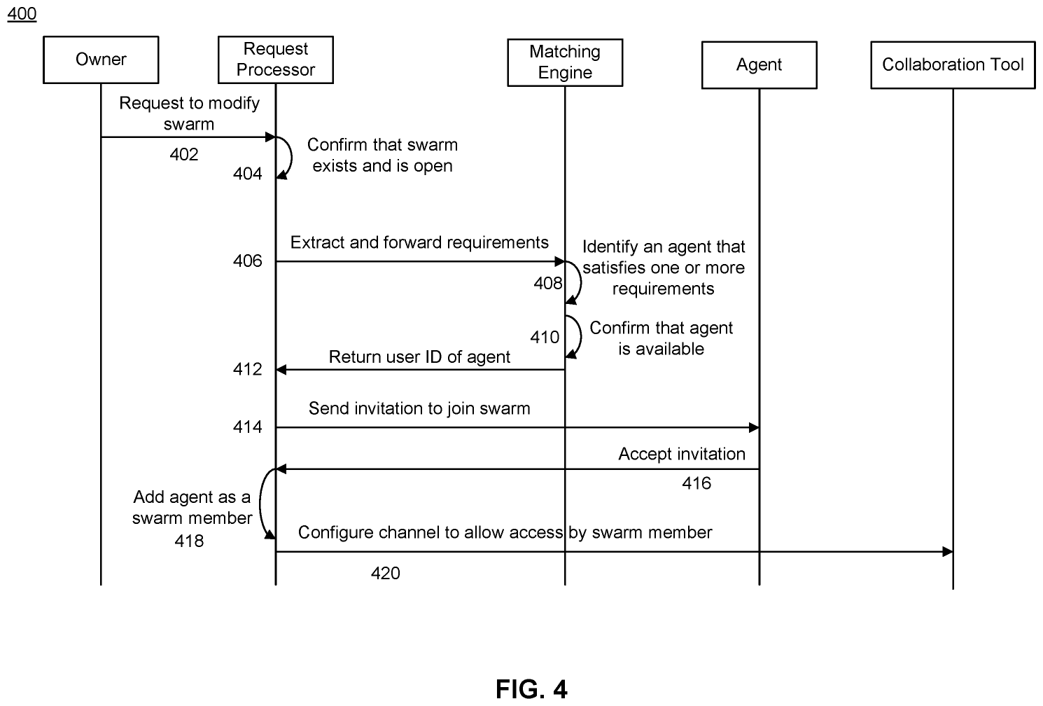

FIG. 4 is a flow diagram of a process 400 for modifying a swarm, in accordance with some implementations. The process 400 can be performed using the same components as the process 300 in FIG. 3. At 402, the request processor receives a request to modify a swarm. The request in 402 can be sent from a computing device of an owner associated with the swarm being modified. In general, the computer system may restrict the ability to modify a swarm to the owner associated with the swarm, but there may be instances where someone besides the owner is permitted to modify the swarm. The request in 402 can include the swarm ID of the swarm.

At 404, the request processor checks to confirm that the swarm indicated in the request in 402 exists and is open. To confirm that the swarm exists and is open, the request processor may perform a lookup in a swarm database (e.g., swarm database 166) using the swarm ID or other information supplied as part of the request in 402. If the swarm either does not exist or is closed, the request processor may generate an error message and processing terminates. Otherwise, the process proceeds to block 406.

At 406, the request processor extracts requirements from the request and forwards the requirements to the matching engine.

At 408, the matching engine identifies an agent that satisfies one or more requirements of the request.

At 410, the matching engine confirms that the agent identified in 408 is available.

At 412, the matching engine returns a user ID of the agent identified in 408.

At 414, the request processor sends an invitation to the agent.

At 416, the agent accepts the invitation.

At 418, the request processor adds the agent as a swarm member.

At 420, the request processor configures the channel to allow access by the swarm member.

The functionality in blocks 408 to 420 can be repeated, e.g., through multiple iterations and as part of a program loop, to identify and send invitations to additional agents who satisfy one or more requirements specified for the swarm. The functionality in blocks 406 to 420 is analogous to that of blocks 314 to 328 in FIG. 3 and can be implemented in the same or a similar manner. The request in 402 is similar to that of the request in 302, except that the request in 302 is for creating a new swarm, whereas the request in 402 is for modifying an existing swarm. The request in 402 can change one or more aspects of the swarm, including any of the requirements (size, required skills, required minimum proficiency values, etc.) that were specified when the swarm was first created.

FIG. 4 shows an example of an agent being added in response to a request to modify a swarm. This can occur, for example, after the swarm members have begun working on a task and a swarm member discovers that help is needed from someone with a skill that the existing members of the swarm do not possess. However, it is also possible that a request to modify a swarm causes a member to be removed from the swarm. For example, the owner or another swarm member may discover that a skill which was previously thought to have been required for completing the task is not actually required or no longer required (e.g., due to a change in task parameters). Upon determining that an existing swarm member is no longer needed, the computer system can send the swarm member a request to leave the swarm. In some implementations, the computer system may be configured to automatically remove a member from a swarm without informing or receiving confirmation from the member.

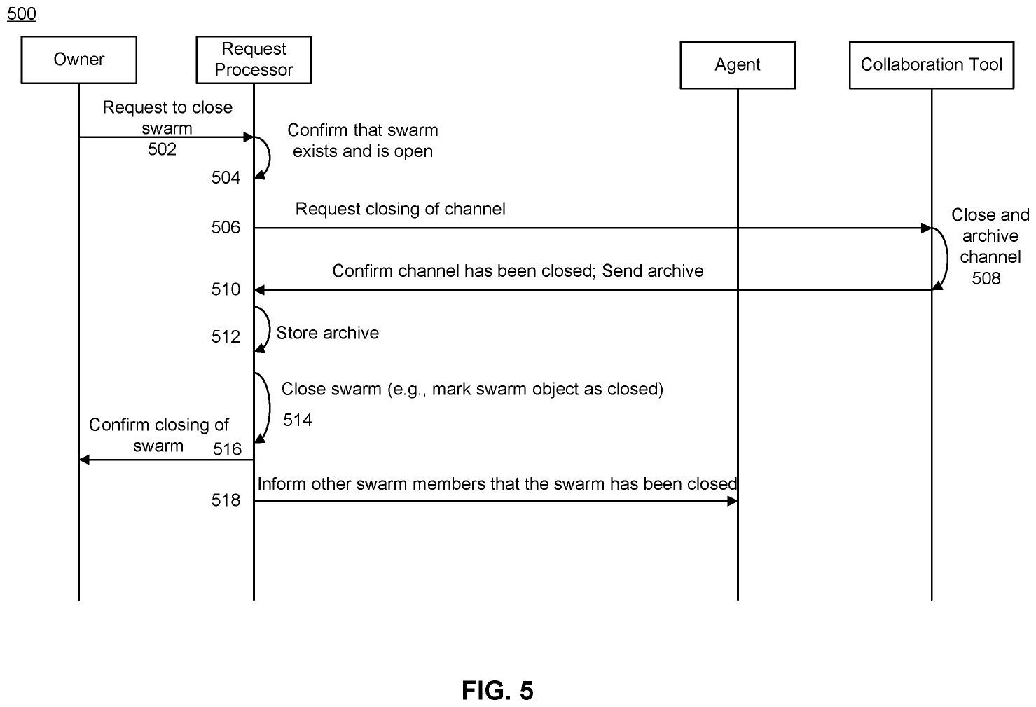

FIG. 5 is a flow diagram of a process 500 for closing a swarm, in accordance with some implementations. The process 500 can be performed using the same components as shown in FIGS. 3 and 4, except that the matching engine need not be involved. At 502, the request processor receives a request to close a swarm. The request in 502 can be sent from a computing device of an owner associated with the swarm being closed. A swarm is usually closed after the task that is the subject of the swarm is completed or the owner determines that further work on the task is no longer needed. In general, the computer system may restrict the ability to close a swarm to the owner associated with the swarm, but there may be instances where someone besides the owner is permitted to close the swarm. For example, in some implementations, the computer system may proceed with closing a swarm after receiving requests to close from a majority or plurality of swarm members.

At 504, the request processor checks to confirm that the swarm exists and is open. If the swarm does not exist or is closed, the request processor may generate an error message and processing terminates. Otherwise, the process proceeds to block 506.

At 506, the request processor sends a request to close a collaboration channel assigned to the swarm. The request to close the collaboration channel is sent to the collaboration tool that provided the channel and can include the channel ID for the swarm and, optionally, the swarm ID and/or other information by which the channel can be identified.

At 508, the collaboration tool closes and archives the channel. Closing the channel may involve deallocating resources associated with the channel (e.g., taking down a website dedicated to the swarm) and removing access to the channel for swarm members (e.g., so that members can no longer exchange messages). Archiving the channel may involve generating an activity log that includes, among other things, chat content or messages exchanged between swarm members from the time that the channel was created to the time of the request in 506.

At 510, the collaboration tool sends a confirmation to the request processor to indicate that the channel has been closed. The collaboration tool may also send the archive or a link to the archive to the request processor.

At 512, the request processor stores the archive. The archive can be stored in a memory or database of the computer system, for example, in the form of a knowledge article at part of the online learning resources 168. In some implementations, the storing of the archive is performed by the collaboration tool.

At 514, the request processor closes the swarm, for example, by marking a swarm object created for the swarm to indicate the closed status.

At 516, the request processor sends a confirmation to the computing device of the owner, indicating that the swarm has been closed. Additionally, the request processor may (at 518) send notifications to other swarm members to inform them that the swarm has been closed.

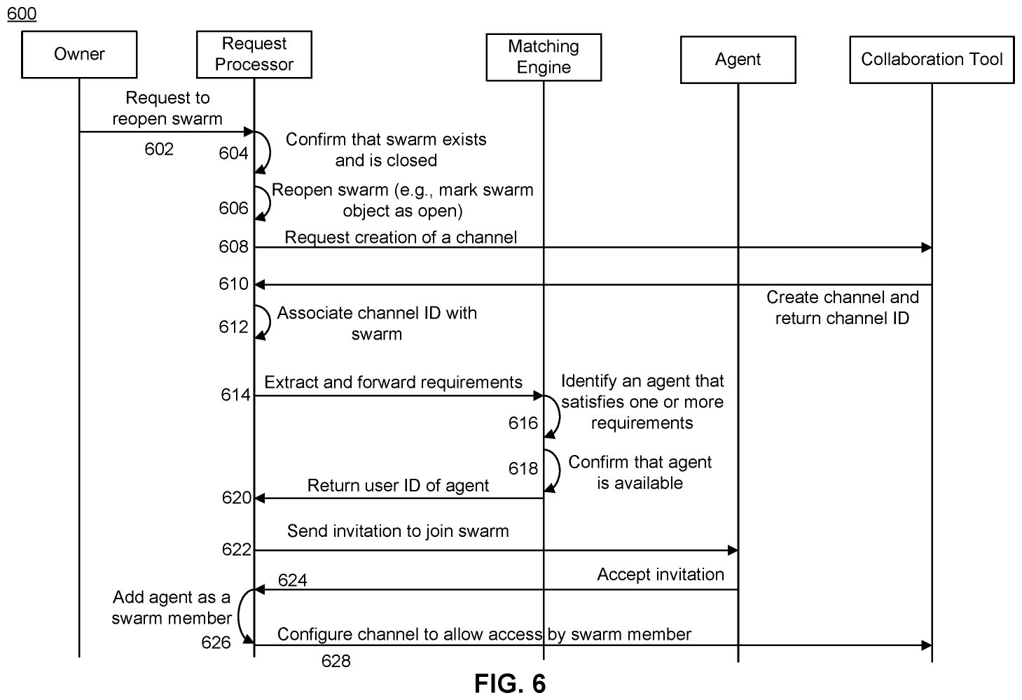

FIG. 6 is a flow diagram of a process 600 for reopening a swarm, in accordance with some implementations. The process 600 can be performed using the same components as shown in FIGS. 3 and 4. The process 600 begins at 602 with the request processor receiving a request to reopen a swarm. The request in 602 can be sent from a computing device of an owner associated with the swarm being reopened and may include the swarm ID of the swarm. A swarm can be reopened for any number of reasons, usually because there is some unsolved or recurring issue that needs to be addressed.

At 604, the request processor checks to confirm that the swarm exists and is closed. If the swarm does not exist or is open, the request processor may generate an error message and processing terminates. Otherwise, the process proceeds to block 606.

At 606, the request processor reopens the swarm by, for example, marking the swarm object created for the swarm as open.

Blocks 608 to 628 include functionality analogous to that of blocks 308 to 328 in FIG. 3 and may be implemented in the same or a similar manner. At 608, the request processor sends a request to a collaboration tool for creating a collaboration channel. The collaboration tool to which the request in 608 is sent can be the same collaboration tool used to create a channel for the swarm earlier, in which case the channel may be assigned the same channel ID as before. This may also cause the collaboration tool to unarchive the channel, for example, by reopening a message board in the same state as when the channel was closed. Alternatively, the request processor may send the request to a different collaboration tool.

At 610, the collaboration tool receiving the request in 608 creates a channel and returns the channel ID.

At 612, the request processor associates the channel ID with the swarm.

At 614, the request processor extracts requirements from the request in 602 and forwards the requirements to the matching engine.

At 616, the matching identifies an agent that satisfies one or more of the requirements.

At 618, the matching engine checks to confirm that the agent identified in 616 is available.

At 620, the matching engine returns the user ID of the agent to the request processor.

At 622, the matching engine sends an invitation to the agent.

At 624, the agent accepts the invitation.

At 626, the request processor adds the agent as a swarm member. The requirements specified in the request in 602 can be the same as or different from the requirements specified when the swarm was initially created. Invitations may be sent to the same agents who were members of the swarm earlier. However, like the modifying of the swarm in FIG. 4, reopening of a swarm may result in membership changes relative to the original membership of the swarm. In some implementations, the matching engine may be configured to identify an entirely new set of swarm members for the swarm being reopened even if the requirements are the same. Alternatively, when one or more requirements are the same, agents who possess a skill that is currently required and who used to be members of the swarm may be prioritized over agents who are new to the swarm.

At 628, the request processor configures the channel to allow access by the swarm member (the agent added in 626).

The functionality in blocks 616 to 628 can be repeated, e.g., through multiple iterations and as part of a program loop, to identify and send invitations to additional agents who satisfy one or more requirements specified for the swarm. In this manner, a swarm can be reopened with the same members as when the swarm was closed or different (e.g., additional) members.

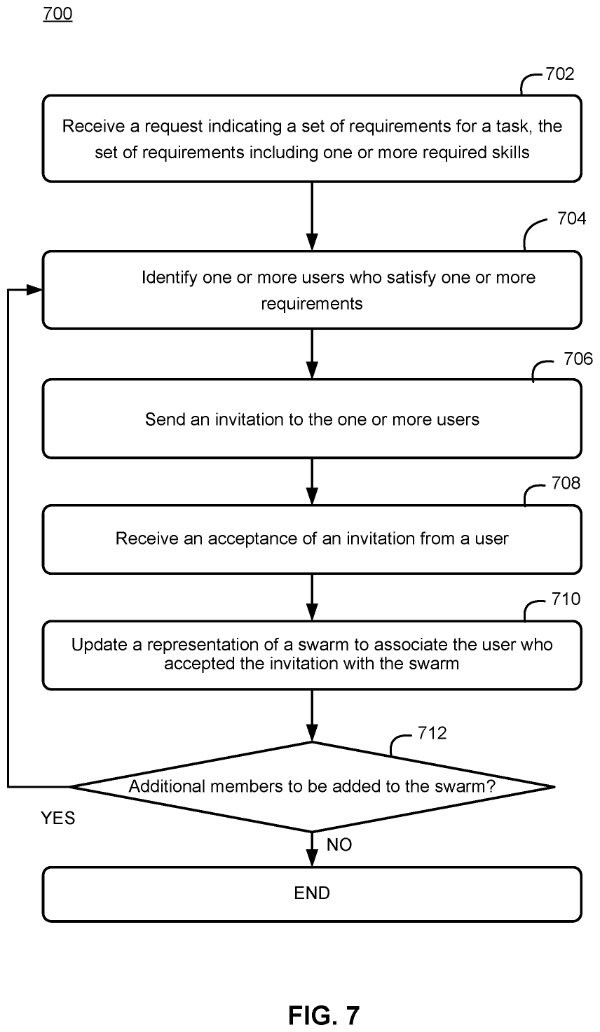

FIG. 7 is a flowchart of a process 700 for adding members to a swarm, in accordance with some implementations. The process 700 includes functionality described above, e.g., in connection with the example of FIG. 3, and can be performed by one or more processors of a computer system with access to user information (e.g., computer system 110). At 702, the computer system receives a request indicating a set of requirements for a task. The request in 702 may, for example, correspond to the request in 302 (a request to create a swarm). Alternatively, the request could be a request to modify a swarm (402) or a request to reopen a swarm (602). If the request in 702 is a request to create a swarm, the request may include information about the task to be completed, for example, a description of the task. As discussed above, requirements that can be specified as part of a swarm request include one or more required skills, possibly in combination with a required skill level (e.g., expressed as a minimum proficiency value) and, in some instances, an indication of how many members are to be added (e.g., total swarm size or total number of agents for a particular skill).

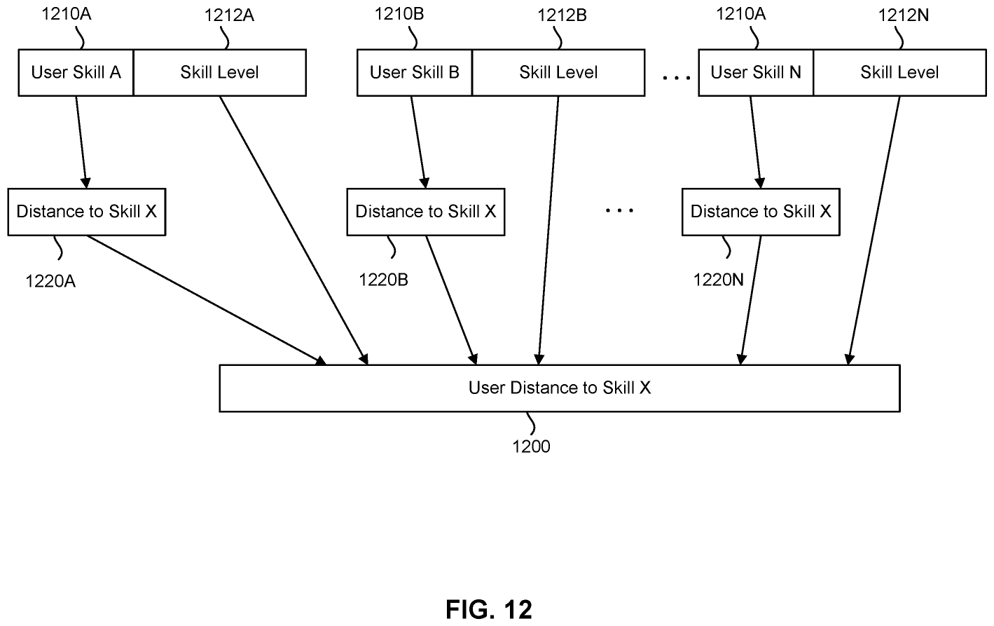

At 704, the computer system identifies one or more users who satisfy at least one of the requirements in the request. The identifying of the one or more users can be performed by a matching engine of the computer system and based on user records maintained by the computer system. The users identified in 704 can include multiple users with different skills and/or different skill levels, depending on the requirements indicated in the request that was received in 702. For example, the functionality in 704 may involve identifying one or more users with a first skill and one or more users with a second skill, where the first skill and the second skill are indicated in the request as being required skills. Further, users who do not meet the skill requirements may be identified. For example, when there are no users with a required skill or a required proficiency level for that skill, the users identified in 704 could include a user who possesses a skill related to the required skill and/or a user who possesses a lower proficiency level than the required proficiency level. Identification of users who do not meet skill requirements can be performed based on a distance-to-user metric such as that described below in connection with FIG. 12, for example, to identify a user with the lowest distance-to-user value.

At 706, the computer system sends an invitation to the one or more users identified in 704. The invitation in 706 is an invitation to join the swarm and may include a link or other interactive option that enables a user receiving the invitation to accept or decline the invitation.

At 708, the computer system receives, in response to one of the invitations sent in 706, an acceptance of the invitation from a user.

At 710, the computer system updates a representation of the swarm (e.g., a swarm object) to associate the user who accepted the invitation with the swarm.

At 712, the computer system determines whether there are additional members to be added to the swarm. If there are no additional members to be added, the process terminates. Otherwise, the process returns to block 704. The determination in 712 can be based on a size specified as part of the request. For example, the computer system may stop identifying users to send invitations to once a total size required for the swarm has been reached and/or once the total number of members required for each of the one or more skills has been reached.

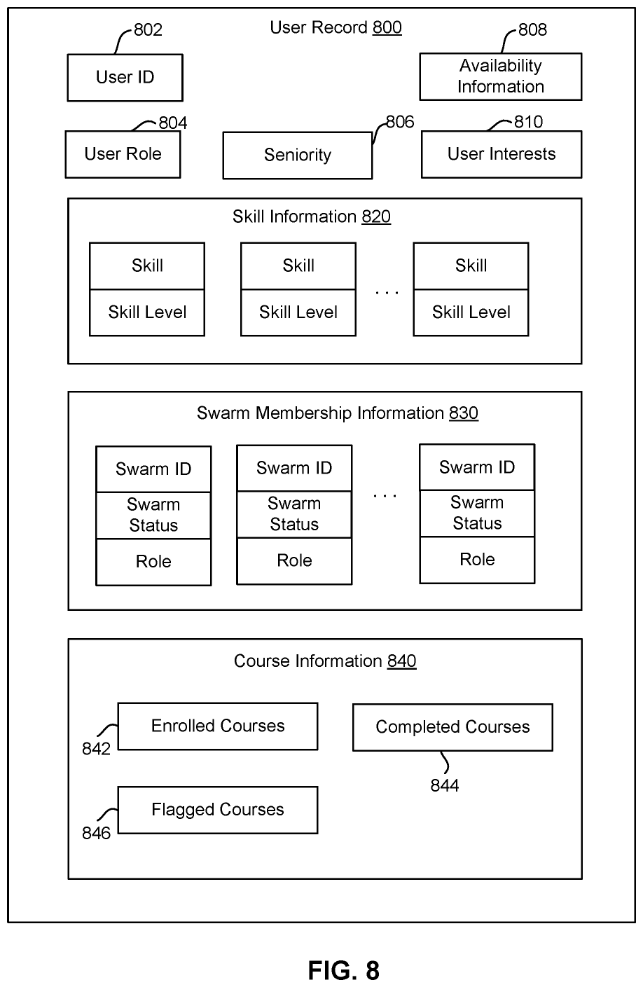

FIG. 8 illustrates a user record 800 according to some implementations. User record 800 may include a user ID 802 and other information that forms a user profile for a user such as a user role 804, seniority 806, availability 808, and user interests 810. The user ID can be a username or other information (e.g., an employee ID number) that uniquely identifies the user. The user role 804 can be a job title or other descriptor of the user's role within an organization. The user seniority 806 is a value that indicates the user's level or seniority in the user role. For example, a junior engineer might have a seniority value of two, whereas a more senior engineer might have a seniority value of seven. The availability 808 is an indicator of the user's availability to join a swarm that the user is not currently assigned to. Availability can be expressed as a simple yes/no or a numeric value, for example, the total number of swarms the user is currently assigned to. User interests 810 can include a list of skills, career goals, and/or other interests that the user has indicated.

Other user profile information that can form the user record 800 include skill information 820, swarm membership information 830, and course information 840. Skill information 820 indicates what skills the user possesses. The skill information 820 can also indicate the skill level in a skill the user possesses. For example, skill level can be expressed as a proficiency value (e.g., a numeric value on a predefined scale or a qualitative value such as low/medium/high).

Computer system 110 can be configured to update skill information contained in a user record. The skill information for one or more users represented in the computer system can be updated with the same frequency as that with which reports are generated. For example, skill analysis system 150 can run daily reports and generate daily updates to user skill information. A user's skill information can change to reflect the addition of a new skill that the user has learned and/or a change in skill level. The computer system 110 can detect such changes based on the user accessing online learning resources (e.g., completing courses) and/or engaging in activity that builds proficiency. For example, as discussed below, a course may have a course skill level associated with it. When a user completes a course, the computer system can update the user's skill level based on the course skill level, for example, by replacing a proficiency value for a skill with the course skill level.

Another way in which the computer system 110 can detect changes in skill is based on swarm activity. In some implementations, the skill analysis system 150 is configured to adjust user skill levels after a swarm has been closed. The closing of the swarm can be an indication that the task the swarm members are working on has been completed, at least in part. The skill analysis system 150 can, in response to closing of the swarm, increase a swarm member's skill level to reflect work in a required skill. The degree to which a user's skill level is increased may be proportional to the total number of swarms that the user has participated in. For example, a user may have been a member of five swarms in which a first skill was a required skill. Based on the user's participation in these five swarms, the skill analysis system 150 can increment the user's skill level in the first skill five times, e.g., by a fixed amount each time. This increase in user skill level can be immediately reflected in the user's information (e.g., a user record 800) when the swarm is closed or, as indicated above, the skill analysis system 150 may perform updates at some regular interval (e.g., a daily update for all users). A user's skill level (e.g., proficiency value) in a skill can increase even if the user did not previously possess the skill. It can be inferred that, through working as part of a swarm, the user has gained experience in each of the skills required for the swarm. The skill analysis system 150 may take into consideration that the user did not previously possess the skill by increasing the user's skill level to a lesser degree than if the user already possessed the skill. In this manner, proficiency in a skill that is new to a user can be gradually built up over time through working on different swarms.

Swarm membership information 830 indicates which swarms the user is currently a member of. In some instances, swarm membership information 830 may also indicate swarms that the user was a member of in the past (e.g., closed swarms). The swarm membership information 830 can include the swarm ID of the swarm, a status of the swarm (e.g., open or closed), and the user's role within the swarm (e.g., owner or agent).

Course information 840 indicates courses or learning resources that the user has accessed (e.g., viewed or enrolled in). Course information 840 may, for example, include enrolled courses 842 that the user is in the process of completing, completed courses 844, and flagged courses 846 corresponding to courses or learning resources that the user has bookmarked for possible future viewing or enrollment.

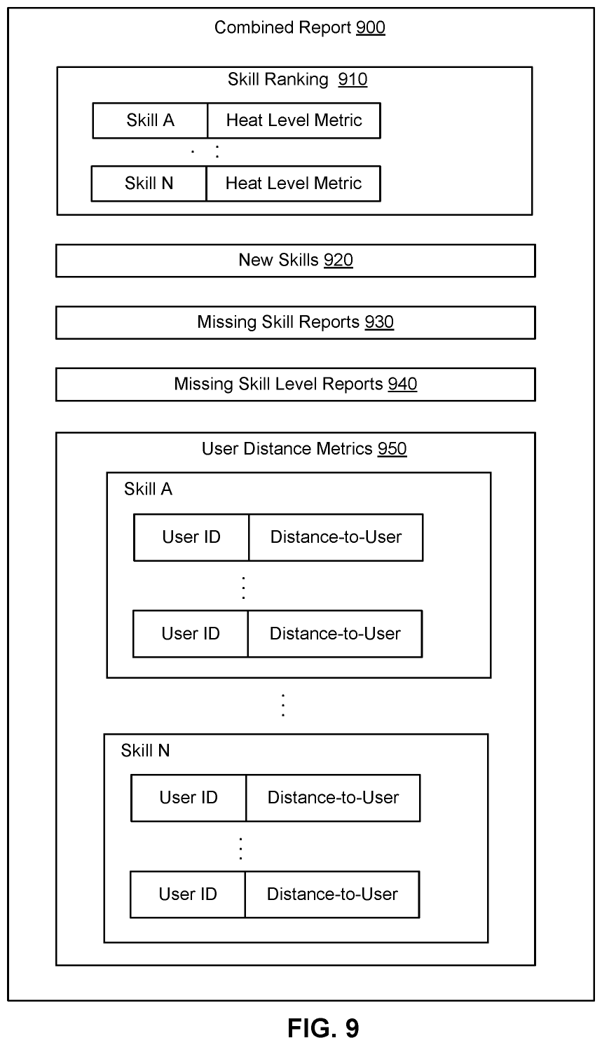

FIG. 9 illustrates a combined report 900 according to some implementations. The combined report 900 includes information aggregated from various reports that a computer system can generate based on swarm activity and information about user skills. For example, combined report 900 can include a ranking 910 of skills according to heat level, a list of new skills 920 identified based on swarm requests, missing skill reports 930, missing skill level reports 940, and user distance metrics 950. Thus, combined report 900 may represent a snapshot of the results of analyzing multiple skills across different users and based on swarm requests received over a period of time (e.g., a daily reporting period).

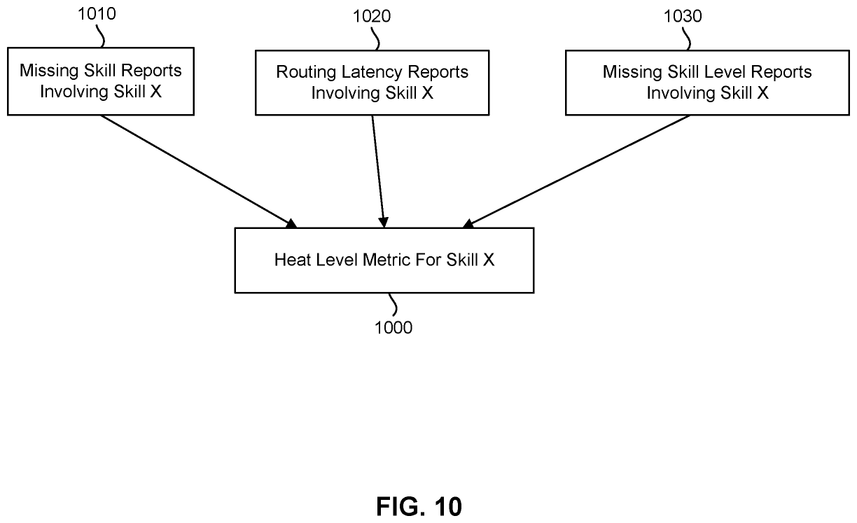

Skill ranking 910 can include a ranked list of all skills known to the computer system or a list of top ranking skills based on a heat level metric. FIG. 10 illustrates an example of how a heat level metric might be calculated. As shown in FIG. 10, a heat level metric 1000 for a particular skill (skill X) can be a value calculated as a function of missing skill reports 1010 involving the skill, routing latency reports 1020 involving the skill, and missing skill level reports 1030 involving the skill.

As discussed above, missing skill reports and missing skill level reports can be generated based on instances in which an agent is assigned to a swarm but lacks a required skill, and missing skill level reports can be generated based on instances in which an agent is assigned to a swarm but lacks a required skill level. For instance, an agent may have been invited to a swarm based on having a skill that is related but not identical to a required skill, in which case a tally of instances in which the required skill is missing can be incremented by one. The computer system can compute a total of how many times a skill was required but assigned to an agent who lacks the required skill (e.g., over a duration spanned by a missing skill report).

Missing skill level can be computed as a difference between an agent's skill level and a required skill level. For example, if skill level is represented as a proficiency value on a scale from one to ten and a swarm has a minimum proficiency value of six for a first skill, but the agent has a proficiency value of four in the first skill, a missing skill level of two can be counted toward a tally of missing skill level for the first skill.

Routing latency is a measure of how long it takes to assign an agent to a swarm based on matching against a required skill. A separate routing latency value can be computed for each assigned agent, for example, based on a difference between a timestamp of when a swarm request was submitted or received and a timestamp of when an agent accepted an invitation. The routing latency value for an assigned agent can be counted toward a total routing latency value for the skill that was the basis for inviting the agent to join a swarm.

In some implementations, heat level may also be a function of an “average level difference,” where the average level difference is an average of missing skill level for a particular skill, e.g., across all instances (within a reporting period) in which the skill was required but an agent who does not have the skill was assigned in the capacity of someone having the skill.

Heat level can be computed for a skill in any number of ways. In some implementations, the heat level of a skill is a weighted sum computed according to the following formula:

Heat level=(#of missing skill*weight1)+(#of missing skill level*average level difference*weight2)+(routing latency*weight3)

where # of missing skill refers to a total count of how many times the skill was required but assigned to an agent who lacks the skill, and# of missing skill level refers to a total count of missing skill level for the skill. The above formula for heat level is merely an example of one way in which a measure of how in-demand a skill is based on statistics regarding usage of the skill as reflected in the processing of swarm requests. Other ways to measure heat level are also possible.

New skills 920 can include a list of all skills that are newly identified based on swarm requests received over the reporting period covered by the combined report 900.

Missing skill reports 930 and missing skill level reports 940 can be summaries of missing skill values and missing skill level values for different skills over the reporting period.

User distance metrics 950 can be a compilation of distance-to-user values computed for different skills. As shown in FIG. 9, multiple distance-to-user values can be computed for each skill in the user distance metrics 950. In some implementations, a separate distance-to-user value is computed for each user represented in the computer system (e.g., all agents) and for every skill in the list of skills maintained by the computer system. Thus, a first skill may have n number of distance-to-user values, where n is equal to the total number of users, and a second skill may also have n number of distance-to-user values.

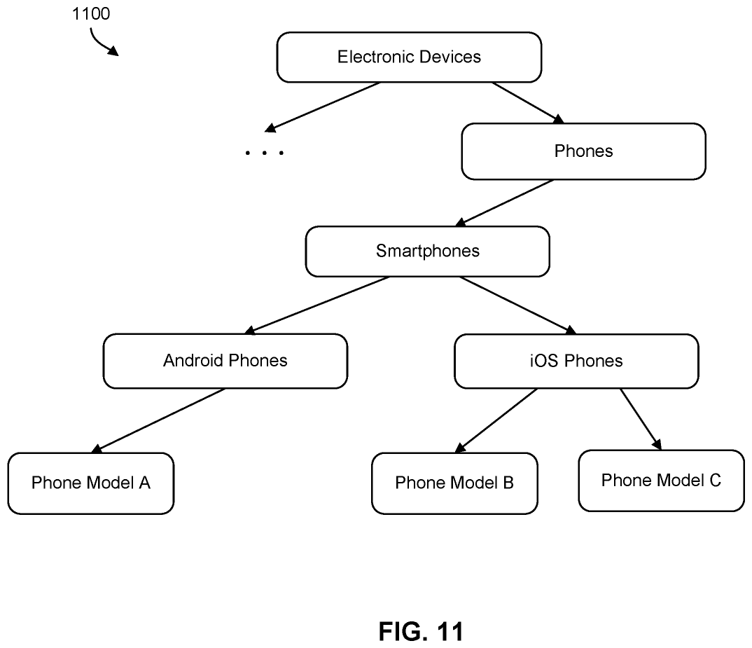

FIG. 11 illustrates an example of a graph 1100 of nodes that can be used to compute a distance-to-user metric, according to some implementations. The graph 1100 is structured as tree in which each node in the tree represents a different category of skill. In the example of FIG. 11, the tree represents skill across different types of smartphones. At the highest level (the root node of the graph 1100), the skill category can be classified as “electronic devices.” Aside from the root node, each node may be connected to a parent node representing a more general skill category. For example, a child of the root node may represent a “phones” skill category. In turn, a child node may be the parent of a more specific category of skill. For example, “smartphones” are a sub-category of phones. Similarly, “Android phones” and “iOS phones” are sub-categories of smartphones and each has specific phone models that agents within an organization may be skilled in. For instance, a user may possess a “trouble-shooting” skill in “phone model A,” a type of Android phone. The level of granularity of the categories represented in a graph of nodes may depend on the types of tasks that are to be completed using swarms and can be customized for each organization/tenant.

Distance-to-user can be computed based on the minimum graph distance (shortest path) between a node representing a required skill category and a node representing a category of skill that a user possesses. For example, referring to FIG. 11, if the required skill is a skill relating to “phone model B” and the skill the agent possesses relates to “phone model C,” the distance-to-user value equals three since three nodes are traversed in going from the node representing phone model B to the node representing phone model C. Similarly, if the required skill relates to phone model B and the skill the agent possesses relates to phone model A, the distance-to-user is equal to five.

FIG. 12 illustrates an example of how a distance-to-user metric 1200 might be calculated. The distance-to-user metric 1200 represents a distance between a user and a required skill (skill X) and is a function of distances between skill X and skills that the user possesses. As shown in FIG. 12, the user may possess n number of skills 1210. For each skill of the n skills the user possesses, a distance value 1220 can be computed to represent the distance between the skill and skill X. The distance value 1220 can be computed, for example, using the graph approach described above in connection with FIG. 11. The distance-to-user metric 1200 can then be computed as a function of the distance values 1220 (e.g., distance values 1220A to 1220N). Further, the distance-to-user metric 1200 may also be a function of the user's skill level in the skills 1210. For example, in some implementations, a distance-to-user is computed as follows:

$$min \{ \frac{dis ( S , {S}_{i} )}{{S}_{i} . level} \} , i = 1 , 2 … n$$

where S is a required skill (skill X in FIG. 12), Sᵢ is a skill the user possesses, and level is the user's skill level or proficiency value for Sᵢ. In the above formula, the distance-to-user is a minimum (smallest) value among a set of values computed for each of the n skills the user possesses. Thus, the distance-to-user metric 1200 can be considered a measure of how close the user is to the required skill based on the extent to which the required skill and a skill that the user possesses are related. A distance-to-user metric (e.g., the metric 1200) can be used to match users, e.g., to identify an agent with the lowest distance-to-user metric as a candidate for joining a swarm. Additionally, a distance-to-user metric can be used to recommend learning resources for a user, as described below.

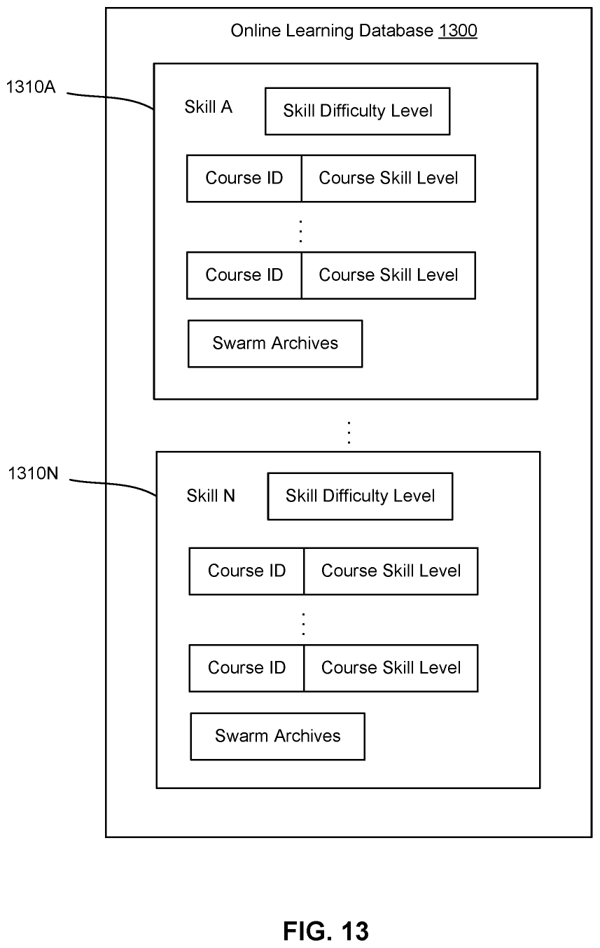

FIG. 13 illustrates an online learning database 1300 according to some implementations. The database 1300 represents a collection of learning resources which, as described above, can include courses relating to specific skills and, in some instances, information derived from swarm activity. As shown in FIG. 13, the database 1300 can include learning resources collected for different skills 1310. Each skill 1310 may have a difficulty level associated with it. For example, in some implementations, each skill in a list of skills maintained by a computer system can be assigned a difficulty value (e.g., on a scale from one to a hundred) indicating the skill's difficulty relative to other skills in the list of skills. Skills that have a higher difficulty value are skills that tend to be more difficult to learn (e.g., time-consuming or involving certification/passing tests).

Learning resources for a skill 1310 may include one or more courses created for the skill. Courses can be identified based on course ID and a course may be assigned a course skill level. The course skill level can be a value representing the degree of skill proficiency a user is expected to have after completing the course. For example, a skill 1310 may have a series of courses with progressively increasing difficulty. In some implementations, course skill level is a value on the same scale as skill difficulty level. For instance, a skill with a difficulty level of eighty may have a series of courses designed to advance a user from course skill level five to course skill level eighty and possibly complete proficiency in the skill. In some cases, multiple courses may be taken to achieve complete proficiency in a skill.

Learning resources can also include information from swarm archives. For instance, when a swarm is closed, an activity log generated by a collaboration tool 140 for the swarm can be stored in association with each of the skills that were required skills for the swarm. The activity log can be in the form of a knowledge article that users are permitted to edit. For instance, members of swarm that was closed may edit a knowledge article to provide comments or other information that supplements conversations included in the knowledge article, thereby helping other users to understand the nature of the conversations and/or the manner in which a task was completed.

As mentioned above, distance-to-user can be used to recommend learning resources to users. For example, in some implementations, the skill analysis system 150 is configured to determine a “course difficulty level” for a user based on a combination of factors including skill difficulty level, course skill level, distance-to-user, and user seniority. The course difficulty level represents how challenging a course is for a particular user. The following formula is an example of how the course difficulty level might be computed for a user:

Course difficulty level to a user=(Skill difficulty level*Course skill level*Distance-to-User)/User seniority

The skill analysis system 150 can compute the course difficulty level after identifying a skill based on heat level. For example, the skill analysis system 150 may determine that, in order to improve (e.g., reduce) the heat level values for the top ten skills ranked by heat level, recommendations should be sent for courses relating to one or more of the top ten skills (e.g., at least the highest ranking skill) and/or courses relating to one or more new skills that have been identified based on incoming swarm requests. To identify which users to send a recommendation to, the skill analysis system 150 can take the course difficulty level into consideration together with other user-specific factors such as user interests. The skill analysis system 150 may, for example, generate a notification recommending a course to a user when the course difficulty level to the user is below a threshold value. Accordingly, the skill analysis system can recommend courses that are of appropriate difficulty for an individual user and which relate to the user's own interests.

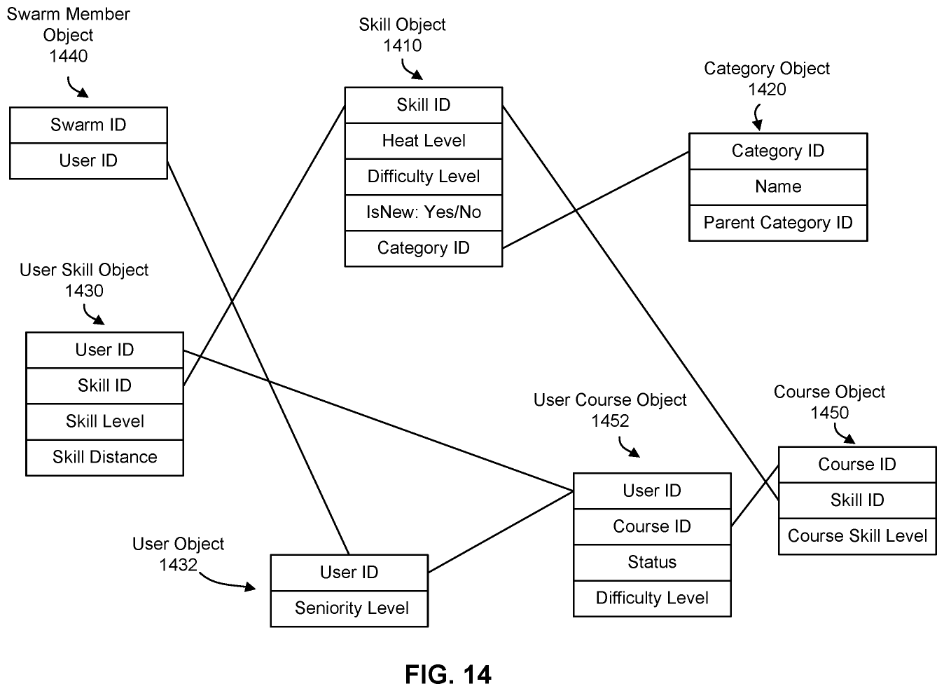

FIG. 14 illustrates an example of a data model usable for representing information in a computer system configured to provide recommendations for learning resources, in accordance with some implementations. FIG. 14 is provided to illustrate how various items of information can be used as attributes that link data objects. The information in FIG. 14 is non-exhaustive. For example, some items of information described above in connection with earlier figures have been omitted for the sake of simplicity.

As shown in FIG. 14, a skill can be represented by a skill object 1410 that includes a skill ID, a heat level, a skill difficulty level, an indication of whether the skill is new or not, and a category ID. Category ID corresponds to an identifier of a category to which a skill belongs. Referring back to FIG. 11, a separate category object 1420 may be stored for each node in the graph 1100. The category object 1420 can include the category ID, a name of the category (e.g., “phones”) and a parent category ID corresponding to the category ID associated with a parent node.

A user can be represented using a combination of a user skill object 1430 and a user object 1432. The user skill object 1430 represents the user as a skill resource and can include a user ID, one or more skill IDs, one or more skill levels/proficiency values, and one or more skill distances (e.g., a distance-to-user for each skill in a list of skills). The user object 1432 represents the user as an agent who can be assigned work and can include the user ID and a seniority level of the user. Thus, the user ID links the user skill object 1430 and the user object 1432 and can be used to look up either of these objects in a database. The user ID can also link to a swarm member object 1440 that the user is associated with.

Learning resources can be represented using course objects 1450. A course object can include a course ID, a course skill level, and a skill ID that links the course object to a skill object 1410 representing a skill involved in the course. When a user begins a course, a user course object 1452 can be created to represent a user-specific instance of the course.

The user course object 1452 can be used to track the user's progress through the course and can include the user ID, the course ID, a status indicator (e.g., course completed/not completed, percentage of completion), and a difficulty level of the course for the user (e.g., a value for the course difficulty level to a user, as described above).

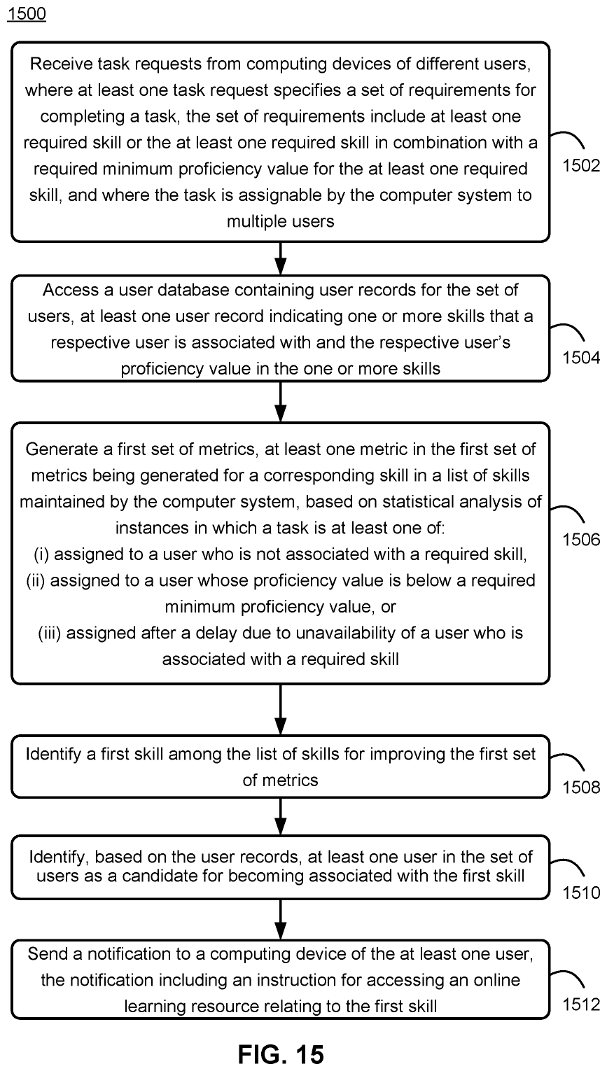

FIG. 15 is a flowchart illustrating a process 1500 for recommending learning resources, in accordance with some implementations. The process 1500 can be performed by one or more processors of a computer system implementing a skill analysis system, e.g., the computer system 110 in FIG. 1. At 1502, the computer system receives task requests from computing devices of different users. The task requests may correspond to one of the different types of swarm requests described earlier, for example, a request to create a swarm or a request to modify a swarm. Accordingly, at least one of the task requests received in 1502 can specify a set of requirements for completing a task. The set of requirements can include at least one required skill or, in some instances, at least one required skill in combination with a required proficiency value for the at least one required skill. The task can be assignable to multiple users, for example, through associating a corresponding swarm object with user IDs of swarm members.

At 1504, the computer system accesses a user database containing user records for the set of users. At least one user record indicates one or more skills that a respective user is associated with. The at least one user record may also indicate the respective user's proficiency value in the one or more skills. For example, as described above in connection with FIG. 8, user record 800 can include skill information 820 that indicates a set of skills and skill levels for a user. The user record accessed in 1504 may also correspond to user skill object 1430 in FIG. 14.

At 1506, the computer system generates a first set of metrics, with at least one metric in the first set of metrics being generated for a corresponding skill in a list of skills maintained by the computer system. The first set of metrics can, for example, include a heat level metric as described above. Accordingly, the computer system may generate the at least one metric based on statistical analysis of instances in which a task (or more specifically, a swarm for which the task is being formed) is at least one of: (i) assigned to a user who is not associated with a required skill, (ii) assigned to a user whose proficiency value is below a required minimum proficiency value, or (iii) assigned after a delay due to unavailability of a user who is associated with a required skill.

Situation (i) refers to the case where an agent is assigned as a swarm member but is missing the required skill that was specified as part of the swarm request. This can occur, for instance, when there are no available agents with the required skill and the matching engine decides to select the closest matching agent (e.g., a user with the lowest distance-to-user value) to fill a vacancy for the required skill.

Situation (ii) refers to the case where an agent is assigned as a swarm member and has a required skill, but the agent's skill level is less than that required for the skill.

Situation (iii) refers to routing latency or time elapsed between receiving a swarm request and an agent accepting an invitation to join the swarm. In practice, there is usually some amount of routing latency involved when someone joins a swarm, attributed to a combination of processing time (e.g., generating and sending invitations) and user delay (e.g., depending on how often an agent checks for pending invitations). However, one of the most significant contributors to routing latency tends to be delay due to unavailability of a user associated with a required skill. The computer system may be configured to disregard (treat as zero) any routing latencies that are below a threshold latency value.

At 1508, the computer system identifies, based on the user records accessed in 1504, a first skill among the list of skills for improving the first set of metrics. For example, the computer system may select one or more skills that have the highest heat level for improvement (e.g., reduction in heat level).

At 1510, the computer system identifies, based on the user records, at least one user in the set of users as a candidate for becoming associated with the first skill. Becoming associated with a skill may involve learning a skill that is new to a user, through completing a course or other learning resource. Alternatively, becoming associated with a skill may involve increasing proficiency in a skill that a user does not already possess. As discussed above, recommendations for learning resources can be provided for users identified based on consideration of distance-to-user plus other user-specific factors such as user interests. Thus, the computer system may, as part of identifying the at least one user, generate a second set of metrics (one or more distance-to-user values) and identify one or more users for whom a learning resource is within a threshold difficulty value. In some implementations, the computer system may determine a number of recommendations sufficient to reduce the heat level of the first skill by a target amount, under the assumption that all of the identified users will follow up by completing a course or other learning resource selected by the computer system.

At 1512, the computer system sends a notification to a computing device of the at least one user. The notification includes an instruction for accessing an online learning resource relating to the first skill. For instance, the notification may include a message recommending that the user take a course in the first skill, along with an explanation of why the user is being notified (e.g., the user indicated interest in learning the first skill or learning skills in the same category as the first skill), and an activatable link that directs the user's computing device to a course database (e.g., a Uniform Resource Locator of a webpage created for the course).

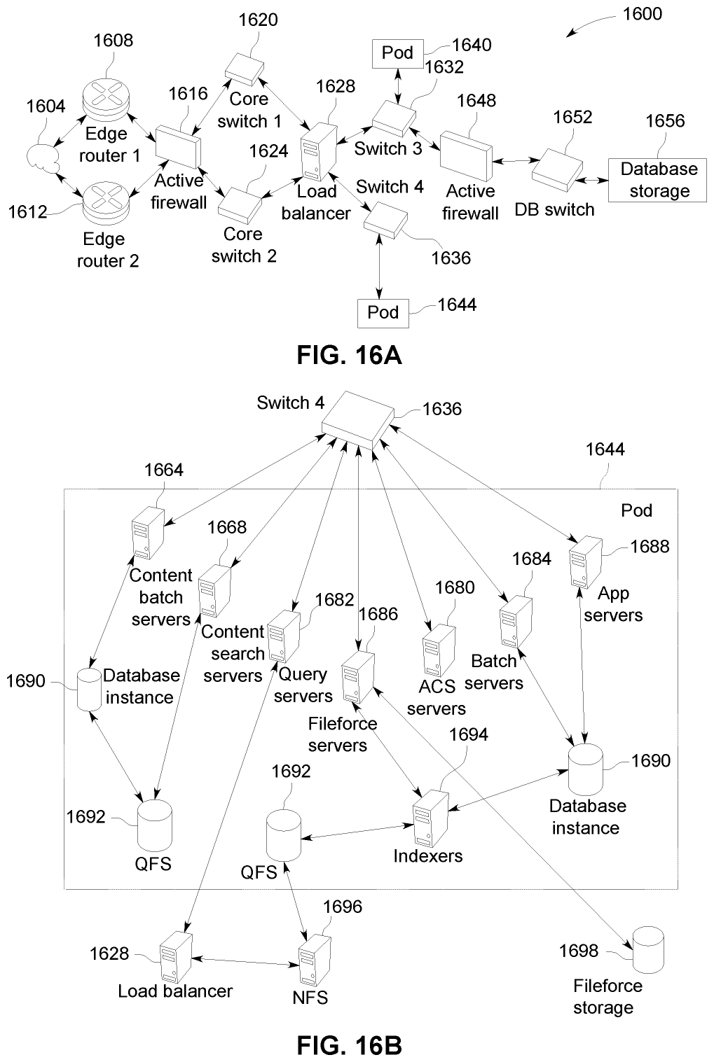

FIG. 16A shows a system diagram illustrating architectural components of an on-demand service environment 1600, in accordance with some implementations. For instance, the on-demand service environment 1600 may correspond to an implementation of computing environment 100 in FIG. 1. A client machine located in the cloud 1604 (or Internet) may communicate with the on-demand service environment via one or more edge routers 1608 and 1612. The edge routers may communicate with one or more core switches 1620 and 1624 via firewall 1616. The core switches may communicate with a load balancer 1628, which may distribute server load over different pods, such as pods 1640 and 1644. The pods 1640 and 1644, which may each include one or more servers and/or other computing resources, may perform data processing and other operations used to provide on-demand services. Communication with the pods may be conducted via pod switches 1632 and 1636. Components of the on-demand service environment may communicate with a database storage system 1656 via a database firewall 1648 and a database switch 1652.

As shown in FIGS. 16A and 16B, accessing an on-demand service environment may involve communications transmitted among a variety of different hardware and/or software components. Further, the on-demand service environment 1600 is a simplified representation of an actual on-demand service environment. For example, while only one or two devices of each type are shown in FIGS. 16A and 16B, some implementations of an on-demand service environment may include anywhere from one to many devices of each type. Also, the on-demand service environment need not include each device shown in FIGS. 16A and 16B or may include additional devices not shown in FIGS. 16A and 16B.

Moreover, one or more of the devices in the on-demand service environment 1600 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1604 is intended to refer to a data network or plurality of data networks, often including the Internet. Client machines located in the cloud 1604 may communicate with the on-demand service environment to access services provided by the on-demand service environment. For example, client machines may access the on-demand service environment to retrieve, store, edit, and/or process information.

In some implementations, the edge routers 1608 and 1612 route packets between the cloud 1604 and other components of the on-demand service environment 1600. The edge routers 1608 and 1612 may employ the Border Gateway Protocol (BGP). The BGP is the core routing protocol of the Internet. The edge routers 1608 and 1612 may maintain a table of IP networks or ‘prefixes’ which designate network reachability among autonomous systems on the Internet.

In one or more implementations, the firewall 1616 may protect the inner components of the on-demand service environment 1600 from Internet traffic. The firewall 1616 may block, permit, or deny access to the inner components of the on-demand service environment 1600 based upon a set of rules and other criteria. The firewall 1616 may act as one or more of a packet filter, an application gateway, a stateful filter, a proxy server, or any other type of firewall.

In some implementations, the core switches 1620 and 1624 are high-capacity switches that transfer packets within the on-demand service environment 1600. The core switches 1620 and 1624 may be configured as network bridges that quickly route data between different components within the on-demand service environment. In some implementations, the use of two or more core switches 1620 and 1624 may provide redundancy and/or reduced latency.

In some implementations, the pods 1640 and 1644 may perform the core data processing and service functions provided by the on-demand service environment. Each pod may include various types of hardware and/or software computing resources. An example of the pod architecture is discussed in greater detail with reference to FIG. 16B.

In some implementations, communication between the pods 1640 and 1644 may be conducted via the pod switches 1632 and 1636. The pod switches 1632 and 1636 may facilitate communication between the pods 1640 and 1644 and client machines located in the cloud 1604, for example via core switches 1620 and 1624. Also, the pod switches 1632 and 1636 may facilitate communication between the pods 1640 and 1644 and the database storage 1656.

In some implementations, the load balancer 1628 may distribute workload between the pods 1640 and 1644. Balancing the on-demand service requests between the pods may assist in improving the use of resources, increasing throughput, reducing response times, and/or reducing overhead. The load balancer 1628 may include multilayer switches to analyze and forward traffic.

In some implementations, access to the database storage 1656 may be guarded by a database firewall 1648. The database firewall 1648 may act as a computer application firewall operating at the database application layer of a protocol stack. The database firewall 1648 may protect the database storage 1656 from application attacks such as structure query language (SQL) injection, database rootkits, and unauthorized information disclosure.

In some implementations, the database firewall 1648 may include a host using one or more forms of reverse proxy services to proxy traffic before passing it to a gateway router. The database firewall 1648 may inspect the contents of database traffic and block certain content or database requests. The database firewall 1648 may work on the SQL application level atop the TCP/IP stack, managing applications' connection to the database or SQL management interfaces as well as intercepting and enforcing packets traveling to or from a database network or application interface.

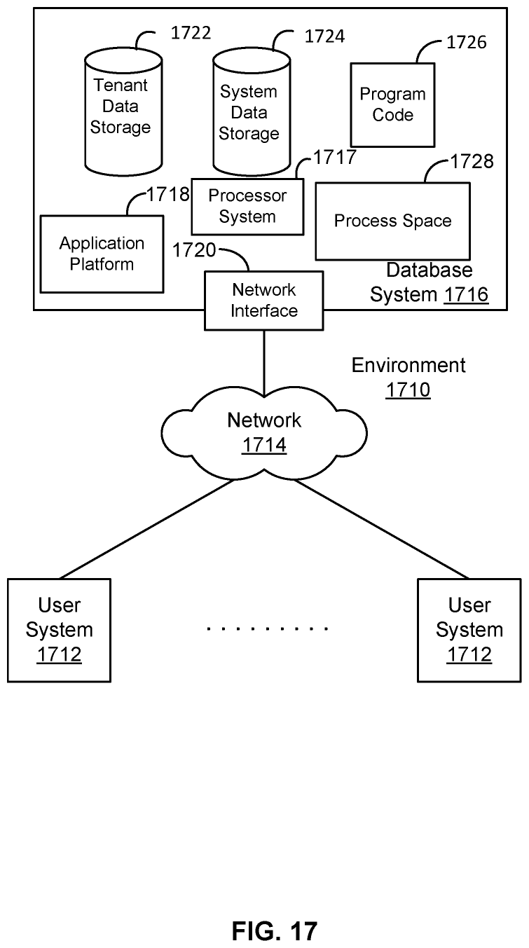

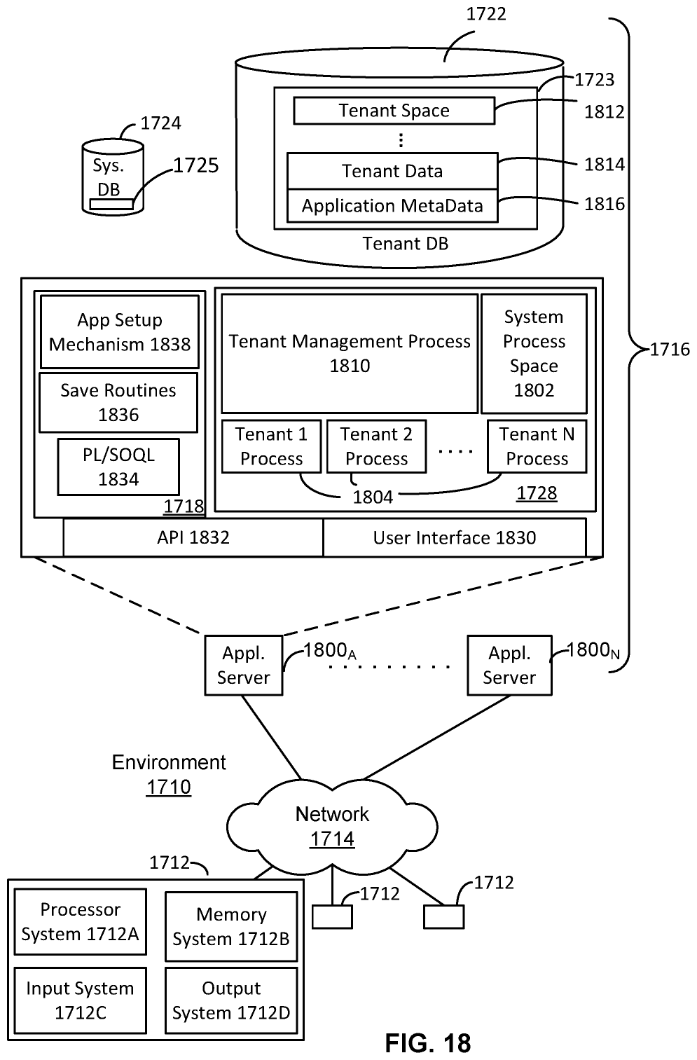

In some implementations, communication with the database storage system 1656 may be conducted via the database switch 1652. The multi-tenant database system 1656 may include more than one hardware and/or software components for handling database queries. Accordingly, the database switch 1652 may direct database queries transmitted by other components of the on-demand service environment (e.g., the pods 1640 and 1644) to the correct components within the database storage system 1656. In some implementations, the database storage system 1656 is an on-demand database system shared by many different organizations. The on-demand database system may employ a multi-tenant approach, a virtualized approach, or any other type of database approach. An on-demand database system is discussed in greater detail with reference to FIGS. 17 and 18.

FIG. 16B shows a system diagram illustrating the architecture of the pod 1644, in accordance with one implementation. The pod 1644 may be used to render services to a user of the on-demand service environment 1600. In some implementations, each pod may include a variety of servers and/or other systems. The pod 1644 includes one or more content batch servers 1664, content search servers 1668, query servers 1682, Fileforce servers 1686, access control system (ACS) servers 1680, batch servers 1684, and app servers 1688. Also, the pod 1644 includes database instances 1690, quick file systems (QFS) 1692, and indexers 1694. In one or more implementations, some or all communication between the servers in the pod 1644 may be transmitted via the switch 1636.

In some implementations, the application servers 1688 may include a hardware and/or software framework dedicated to the execution of procedures (e.g., programs, routines, scripts) for supporting the construction of applications provided by the on-demand service environment 1600 via the pod 1644. Some such procedures may include operations for providing the services described herein. The content batch servers 1664 may handle requests internal to the pod. These requests may be long-running and/or not tied to a particular customer. For example, the content batch servers 1664 may handle requests related to log mining, cleanup work, and maintenance tasks.

The content search servers 1668 may provide query and indexer functions. For example, the functions provided by the content search servers 1668 may allow users to search through content stored in the on-demand service environment. The Fileforce servers 1686 may manage requests for information stored in the Fileforce storage 1698. The Fileforce storage 1698 may store information such as documents, images, and basic large objects (BLOBs). By managing requests for information using the Fileforce servers 1686, the image footprint on the database may be reduced.

The query servers 1682 may be used to retrieve information from one or more file systems. For example, the query servers 1682 may receive requests for information from the app servers 1688 and then transmit information queries to network file systems (NFS) 1696 located outside the pod. The pod 1644 may share a database instance 1690 configured as a multi-tenant environment in which different organizations share access to the same database. Additionally, services rendered by the pod 1644 may require various hardware and/or software resources. In some implementations, the ACS servers 1680 may control access to data, hardware resources, or software resources.

In some implementations, the batch servers 1684 may process batch jobs, which are used to run tasks at specified times. Thus, the batch servers 1684 may transmit instructions to other servers, such as the app servers 1688, to trigger the batch jobs. For some implementations, the QFS 1692 may be an open source file system available from Sun Microsystems® of Santa Clara, Calif. The QFS may serve as a rapid-access file system for storing and accessing information available within the pod 1644. The QFS 1692 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1668 and/or indexers 1694 to identify, retrieve, move, and/or update data stored in the NFS 1696 and/or other storage systems.

In some implementations, one or more query servers 1682 may communicate with the NFS 1696 to retrieve and/or update information stored outside of the pod 1644. The NFS 1696 may allow servers located in the pod 1644 to access information to access files over a network in a manner similar to how local storage is accessed. In some implementations, queries from the query servers 1682 may be transmitted to the NFS 1696 via the load balancer 1628, which may distribute resource requests over various resources available in the on-demand service environment. The NFS 1696 may also communicate with the QFS 1692 to update the information stored on the NFS 1696 and/or to provide information to the QFS 1692 for use by servers located within the pod 1644.

In some implementations, the pod may include one or more database instances 1690. The database instance 1690 may transmit information to the QFS 1692. When information is transmitted to the QFS, it may be available for use by servers within the pod 1644 without requiring an additional database call. In some implementations, database information may be transmitted to the indexer 1694. Indexer 1694 may provide an index of information available in the database 1690 and/or QFS 1692. The index information may be provided to Fileforce servers 1686 and/or the QFS 1692.

FIG. 17 shows a block diagram of an environment 1710 wherein an on-demand database service might be used, in accordance with some implementations. Environment 1710 includes an on-demand database service 1716. User system 1712 may be any machine or system that is used by a user to access a database user system. For example, any of user systems 1712 can be a handheld computing system, a mobile phone, a laptop computer, a workstation, and/or a network of computing systems. As illustrated in FIGS. 17 and 18, user systems 1712 might interact via a network 1714 with the on-demand database service 1716.

An on-demand database service, such as system 1716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1716” and “system 1716” will be used interchangeably herein. A database image may include one or more database objects. A relational database management system (RDBMS) or the equivalent may execute storage and retrieval of information against the database object(s). Application platform 1718 may be a framework that allows the applications of system 1716 to run, such as the hardware and/or software, e.g., the operating system. In an implementation, on-demand database service 1716 may include an application platform 1718 that enables creation, managing and executing one or more applications developed by the provider of the on-demand database service, users accessing the on-demand database service via user systems 1712, or third party application developers accessing the on-demand database service via user systems 1712.

One arrangement for elements of system 1716 is shown in FIG. 17, including a network interface 1720, application platform 1718, tenant data storage 1722 for tenant data 1723, system data storage 1724 for system data 1725 accessible to system 1716 and possibly multiple tenants, program code 1726 for implementing various functions of system 1716, and a process space 1728 for executing MTS system processes and tenant-specific processes, such as running applications as part of an application hosting service. Additional processes that may execute on system 1716 include database indexing processes.

The users of user systems 1712 may differ in their respective capacities, and the capacity of a particular user system 1712 might be entirely determined by permissions (permission levels) for the current user. For example, where a call center agent is using a particular user system 1712 to interact with system 1716, the user system 1712 has the capacities allotted to that call center agent. However, while an administrator is using that user system to interact with system 1716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 1714 is any network or combination of networks of devices that communicate with one another. For example, network 1714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 1712 might communicate with system 1716 using TCP/IP and, at a higher network level, use other common Internet protocols to communicate, such as HTTP, FTP, AFS, WAP, etc. In an example where HTTP is used, user system 1712 might include an HTTP client commonly referred to as a “browser” for sending and receiving HTTP messages to and from an HTTP server at system 1716. Such an HTTP server might be implemented as the sole network interface between system 1716 and network 1714, but other techniques might be used as well or instead. In some implementations, the interface between system 1716 and network 1714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some implementations, system 1716, shown in FIG. 17, implements a web-based customer relationship management (CRM) system. For example, in some implementations, system 1716 includes application servers configured to implement and execute CRM software applications as well as provide related data, code, forms, webpages and other information to and from user systems 1712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain implementations, system 1716 implements applications other than, or in addition to, a CRM application. For example, system 1716 may provide tenant access to multiple hosted (standard and custom) applications. User (or third party developer) applications, which may or may not include CRM, may be supported by the application platform 1718, which manages creation, storage of the applications into one or more database objects and executing of the applications in a virtual machine in the process space of the system 1716.

Each user system 1712 could include a desktop personal computer, workstation, laptop, PDA, cell phone, or any wireless access protocol (WAP) enabled device or any other computing system capable of interfacing directly or indirectly to the Internet or other network connection. User system 1712 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 1712 to access, process and view information, pages and applications available to it from system 1716 over network 1714.

Each user system 1712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1716 or other systems or servers. For example, the user interface device can be used to access data and applications hosted by system 1716, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 1712 and all of its components are operator configurable using applications, such as a browser, including computer code run using a central processing unit such as an Intel Pentium® processor or the like. Similarly, system 1716 (and additional instances of an MTS, where more than one is present) and all of their components might be operator configurable using application(s) including computer code to run using a central processing unit such as processor system 1717, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 1716 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 1716 is configured to provide webpages, forms, applications, data and media content to user (client) systems 1712 to support the access by user systems 1712 as tenants of system 1716. As such, system 1716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 18 also shows a block diagram of environment 1710 further illustrating system 1716 and various interconnections, in accordance with some implementations. FIG. 18 shows that user system 1712 may include processor system 1712A, memory system 1712B, input system 1712C, and output system 1712D. FIG. 17 shows network 1714 and system 1716. FIG. 18 also shows that system 1716 may include tenant data storage 1722, tenant data 1723, system data storage 1724, system data 1725, User Interface (UI) 1830, Application Program Interface (API) 1832, PL/SOQL 1834, save routines 1836, application setup mechanism 1838, applications servers 1800A-1800N, system process space 1802, tenant process spaces 1804, tenant management process space 1810, tenant storage area 1812, user storage 1814, and application metadata 1816. In other implementations, environment 1710 may not have the same elements as those listed above and/or may have other elements instead of, or in addition to, those listed above.

User system 1712, network 1714, system 1716, tenant data storage 1722, and system data storage 1724 were discussed above in FIG. 17. Regarding user system 1712, processor system 1712A may be any combination of processors. Memory system 1712B may be any combination of one or more memory devices, short term, and/or long term memory. Input system 1712C may be any combination of input devices, such as keyboards, mice, trackballs, scanners, cameras, and/or interfaces to networks. Output system 1712D may be any combination of output devices, such as monitors, printers, and/or interfaces to networks. As shown by FIG. 18, system 1716 may include a network interface 1720 (of FIG. 17) implemented as a set of HTTP application servers 1800, an application platform 1718, tenant data storage 1722, and system data storage 1724. Also shown is system process space 1802, including individual tenant process spaces 1804 and a tenant management process space 1810. Each application server 1800 may be configured to tenant data storage 1722 and the tenant data 1723 therein, and system data storage 1724 and the system data 1725 therein to serve requests of user systems 1712. The tenant data 1723 might be divided into individual tenant storage areas 1812, which can be either a physical arrangement and/or a logical arrangement of data. Within each tenant storage area 1812, user storage 1814 and application metadata 1816 might be similarly allocated for each user. For example, a copy of a user's most recently used (MRU) items might be stored to user storage 1814. Similarly, a copy of MRU items for an entire organization that is a tenant might be stored to tenant storage area 1812. A UI 1830 provides a user interface and an API 1832 provides an application programmer interface to system 1716 resident processes to users and/or developers at user systems 1712. The tenant data and the system data may be stored in various databases, such as Oracle™ databases.

Application platform 1718 includes an application setup mechanism 1838 that supports application developers' creation and management of applications, which may be saved as metadata into tenant data storage 1722 by save routines 1836 for execution by subscribers as tenant process spaces 1804 managed by tenant management process 1810 for example. Invocations to such applications may be coded using PL/SOQL 1834 that provides a programming language style interface extension to API 1832. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 1816 for the subscriber making the invocation and executing the metadata as an application in a virtual machine.

Each application server 1800 may be communicably coupled to database systems, e.g., having access to system data 1725 and tenant data 1723, via a different network connection. For example, one application server 1800 might be coupled via the network 1714 (e.g., the Internet), another application server 1800 might be coupled via a direct network link, and another application server 1800 might be coupled by yet a different network connection. Transfer Control Protocol and Internet Protocol (TCP/IP) are typical protocols for communicating between application servers 1800 and the database system. However, other transport protocols may be used to optimize the system depending on the network interconnect used.

In certain implementations, each application server 1800 is configured to handle requests for any user associated with any organization that is a tenant. Because it is desirable to be able to add and remove application servers from the server pool at any time for any reason, there is preferably no server affinity for a user and/or organization to a specific application server 1800. In some implementations, therefore, an interface system implementing a load balancing function (e.g., an F5 Big-IP load balancer) is communicably coupled between the application servers 1800 and the user systems 1712 to distribute requests to the application servers 1800. In some implementations, the load balancer uses a least connections algorithm to route user requests to the application servers 1800. Other examples of load balancing algorithms, such as round robin and observed response time, also can be used. For example, in certain implementations, three consecutive requests from the same user could hit three different application servers 1800, and three requests from different users could hit the same application server 1800. In this manner, system 1716 is multi-tenant, wherein system 1716 handles storage of, and access to, different objects, data and applications across disparate users and organizations.

As an example of storage, one tenant might be a company that employs a sales force where each call center agent uses system 1716 to manage their sales process. Thus, a user might maintain contact data, leads data, customer follow-up data, performance data, goals and progress data, etc., all applicable to that user's personal sales process (e.g., in tenant data storage 1722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1716 might also maintain system level data usable by multiple tenants or other data. Such system level data might include industry reports, news, postings, and the like that are sharable among tenants.

In certain implementations, user systems 1712 (which may be client machines/systems) communicate with application servers 1800 to request and update system-level and tenant-level data from system 1716 that may require sending one or more queries to tenant data storage 1722 and/or system data storage 1724. System 1716 (e.g., an application server 1800 in system 1716) automatically generates one or more SQL statements (e.g., SQL queries) that are designed to access the desired information. System data storage 1724 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
receiving, by a computer system, task requests from computing devices of different users, wherein at least one task request specifies a set of requirements for completing a task, the set of requirements including at least one required skill or the at least one required skill in combination with a required minimum proficiency value for the at least one required skill, and wherein the task is assignable by the computer system to multiple users within a set of users;
accessing, by the computer system, a user database containing user records for the set of users, at least one user record indicating one or more skills that a respective user is associated with and the respective user's proficiency value in the one or more skills;
generating, by the computer system, a first set of metrics, at least one metric in the first set of metrics being generated for a corresponding skill in a list of skills maintained by the computer system, based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill;
identifying, by the computer system, a first skill among the list of skills for improving the first set of metrics;
identifying, by the computer system based on the user records, at least one user in the set of users as a candidate for becoming associated with the first skill; and
sending, by the computer system, a notification to a computing device of the at least one user, the notification including an instruction for accessing an online learning resource relating to the first skill.

2. The method of claim 1, wherein identifying the at least one user comprises:
generating a second set metrics, at least one metric in the second set of metrics representing a distance between the first skill and a respective user and being generated as a function of a distance between the first skill and the one or more skills that the respective user is associated with;
determining, based on the second set of metrics, a difficulty value of the online learning resource for individual users; and
identifying one or more users for whom the online learning resource is within a threshold difficulty value.

3. The method of claim 2, wherein the at least one metric in the second set of metrics is further generated as a function of the respective user's proficiency value in the one or more skills that the respective user is associated with.

4. The method of claim 2, further comprising:
determining, by the computer system, the distance between the first skill and the one or more skills that the respective user is associated with based on a graph of nodes, wherein nodes in the graph of nodes represent different skills, and wherein connections between nodes indicate related skills.

5. The method of claim 1, further comprising:
updating, by the computer system, the user records to reflect changes in skill associations or proficiency values, wherein the online learning resource includes a course, and wherein the updating of the user records is based on detecting, by the computer system, at least one of completion of the course by a user or completion of an assigned task.

6. The method of claim 5, wherein updating the user records to reflect changes in skill associations or proficiency values comprises:
updating a user record of a user who completed the course to indicate a proficiency value associated with the course.

7. The method of claim 5, wherein updating the user records to reflect changes in skill associations or proficiency values comprises:
determining an increase in a first user's proficiency value in a second skill as a result of completion of a first task that the first user was assigned to, the second skill being a required skill for the first task; and
updating a user record of the first user to reflect the increase in the first user's proficiency value in the second skill.

8. The method of claim 7, wherein prior to completing the first task, the first user was not associated with the second skill.

9. The method of claim 1, further comprising:
ranking, by the computer system, the list of skills according to the first set of metrics, wherein a skill's rank increases as a number of instances in which a task requiring the skill is assigned to a user who is not associated with the skill increases; and
identifying the first skill as being a highest-ranking skill.

10. The method of claim 1, further comprising:
ranking, by the computer system, the list of skills according to the first set of metrics, wherein a skill's rank increases as a number of instances in which a task is assigned to a user whose proficiency value in the skill is below a required minimum proficiency value increases; and
identifying the first skill as being a highest-ranking skill.

11. The method of claim 1, further comprising:
ranking, by the computer system, the list of skills according to the first set of metrics, wherein a skill's rank increases as an average or total delay in assigning tasks requiring the skill increases; and
identifying the first skill as being a highest-ranking skill.

12. The method of claim 1, wherein the online learning resource is a course in a course database maintained by the computer system, and wherein the notification comprises a link that, when activated from the computing device of the at least one user, directs the computing device of the at least one user to the course in the course database.

13. The method of claim 1, wherein the online learning resource includes a record stored by the computer system in association with the first skill, the record comprising a log of online activity among a group of users assigned to a task that has been completed and for which the first skill was a required skill.

14. The method of claim 1, further comprising:
determining, by the computer system, that a first required skill specified in a first task request is not included in the list of skills; and
responsive to determining that the first required skill is not included in the list of skills:
adding, by the computer system, the first required skill to the list of skills;
generating, by the computer system, a request to create an online learning resource for the first required skill;
identifying, by the computer system, a subset of users who are associated with one or more skills related to the first required skill; and
sending, by the computer system, the request to create the online learning resource for the first required skill to computing devices of the subset of users.

15. A computer system comprising:
one or more processors; and
memory storing instructions that, when executed by the one or more processors, configure the computer system to:
receive task requests from computing devices of different users, wherein at least one task request specifies a set of requirements for completing a task, the set of requirements including at least one required skill or the at least one required skill in combination with a required minimum proficiency value for the at least one required skill, and wherein the task is assignable by the computer system to multiple users within a set of users;
access a user database containing user records for the set of users, at least one user record indicating one or more skills that a respective user is associated with and the respective user's proficiency value in the one or more skills;
generate a first set of metrics, at least one metric in the first set of metrics being generated for a corresponding skill in a list of skills maintained by the computer system, based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill;
identify a first skill among the list of skills for improving the first set of metrics;
identify, based on the user records, at least one user in the set of users as a candidate for becoming associated with the first skill; and
send a notification to a computing device of the at least one user, the notification including an instruction for accessing an online learning resource relating to the first skill.

16. The computer system of claim 15, wherein to identify the at least one user, the computer system is configured to:
generate a second set metrics, at least one metric in the second set of metrics representing a distance between the first skill and a respective user and being generated as a function of a distance between the first skill and the one or more skills that the respective user is associated with;
determine, based on the second set of metrics, a difficulty value of the online learning resource for individual users; and
identify one or more users for whom the online learning resource is within a threshold difficulty value.

17. The computer system of claim 16, wherein the at least one metric in the second set of metrics is further generated as a function of the respective user's proficiency value in the one or more skills that the respective user is associated with.

18. The computer system of claim 16, wherein the computer system is configured to determine the distance between the first skill and the one or more skills that the respective user is associated with based on a graph of nodes, and wherein nodes in the graph of nodes represents different skills, and wherein connections between nodes indicate related skills.

19. The computer system of claim 15, wherein the computer system is configured to
update the user records to reflect changes in skill associations or proficiency values, wherein the online learning resource includes a course, and wherein to update the user records the computer system detects at least one of completion of the course by a user or completion of an assigned task.

20. A non-transitory computer-readable medium storing program code, the program code including instructions that are executable by one or more processors of a computer system to configure the computer system to:
receive task requests from computing devices of different users, wherein at least one task request specifies a set of requirements for completing a task, the set of requirements including at least one required skill or the at least one required skill in combination with a required minimum proficiency value for the at least one required skill, and wherein the task is assignable by the computer system to multiple users within a set of users;
access a user database containing user records for the set of users, at least one user record indicating one or more skills that a respective user is associated with and the respective user's proficiency value in the one or more skills;
generate a first set of metrics, at least one metric in the first set of metrics being generated for a corresponding skill in a list of skills maintained by the computer system, based on statistical analysis of instances in which a task is at least one of: (i) assigned to a user who is not associated with a required skill, (ii) assigned to a user whose proficiency value is below a required minimum proficiency value, or (iii) assigned after a delay due to unavailability of a user who is associated with a required skill;
identify a first skill among the list of skills for improving the first set of metrics;
identify, based on the user records, at least one user in the set of users as a candidate for becoming associated with the first skill; and
send a notification to a computing device of the at least one user, the notification including an instruction for accessing an online learning resource relating to the first skill.
